(19) United States
(12) Patent Application Publication
(10) Pub. No.: US 2025/0246855 A1
(43) Pub. Date: Jul. 31, 2025

(54) HIGH SPEED ELECTRICAL CONNECTOR AND CONNECTOR SUBASSEMBLY THEREOF

(71) Applicant: Amphenol Commercial Products (Chengdu) Co., Ltd., Chengdu (CN)

(72) Inventors: Rui He, Chengdu (CN); Xiaodong Hu, Chengdu (CN); Yaohua Hou, Chengdu (CN); Lei Liao, Shenzhen (CN)

(73) Assignee: Amphenol Commercial Products (Chengdu) Co., Ltd., Chengdu (CN)

(21) Appl. No.: 19/041,901

(22) Filed: Jan. 30, 2025

(30) Foreign Application Priority Data
Jan. 31, 2024 (CN) 202420246304.5

(51) Int. Cl. H01R 13/6585; H01R 12/72

(52) U.S. Cl. CPC H01R 13/6585; H01R 12/727

(57) ABSTRACT

A connector for use with high-speed signals. The connector includes a subassembly having conductors disposed in groups. Some groups include pairs of conductors. Each pair has mating ends having a pitch greater than the respective intermediate portions. The subassembly may include a shielding shell having openings that expose mating ends. The shielding shell has first portions disposed between adjacent conductor groups and separated by the openings, and a second portion joining the first portions. The second portion has a body and contact arms extending from the body and configured to contact a complementary conductive member of a mating component. The contact arms contact the complementary conductive member at locations closer to a distal end of the complementary conductive member than the conductor mating ends. Such a configuration meets signal integrity requirements in connectors designed for 64 Gbps and beyond, while conforming to a standard that constrains mating and mounting interfaces.

### CROSS-REFERENCE TO RELATED APPLICATIONS

This application claims priority to and the benefit of Chinese Patent Application No. 202420246304.5, filed on Jan. 31, 2024. The contents of this application are incorporated herein by reference in their entirety.

### TECHNICAL FIELD

This application relates to interconnection systems, such as those including electrical connectors, configured to interconnect electronic assemblies.

### BACKGROUND

Electrical connectors are used in many electronic systems. It is generally easier and more cost effective to manufacture a system as separate electronic subassemblies, such as printed circuit boards (PCBs), which may be joined together with electrical connectors. Having separable connectors enables components of the electronic system manufactured by different manufacturers to be readily assembled. Separable connectors also enable components to be readily replaced after the system is assembled, either to replace defective components or to upgrade the system with higher performance components.

A known arrangement for joining several printed circuit boards is to have one printed circuit board serve as a backplane. A known backplane is a PCB onto which many connectors may be mounted. Conductive traces in the backplane may be electrically connected to signal conductors in the connectors so that signals may be routed between the connectors. Other printed circuit boards, called as “daughterboards,” “daughtercards,” or “midboards,” may be connected through the backplane. For example, daughtercards may also have connectors mounted thereon. The connectors mounted on a daughtercard may be plugged into the connectors mounted on the backplane. In this way, signals may be routed among daughtercards through the connectors and the backplane. The daughtercards may be plugged into the backplane at a right angle. The connectors used for these applications may therefore include a right angle bend and are often called as “right angle connectors.”

Connectors may also be used in other configurations for interconnecting printed circuit boards. Sometimes, one or more printed circuit boards may be connected to another printed circuit board, called as a “motherboard,” that is both populated with electronic components and interconnects the daughterboards. In such a configuration, the printed circuit boards connected to the motherboard may be called as daughterboards. The daughterboards are often smaller than the motherboard and may sometimes be aligned parallel to the motherboard. Connectors used for this configuration are often called as “stacking connectors” or “mezzanine connectors”. In other systems, the daughterboards may be perpendicular to the motherboard.

For example, this configuration is often used in computers in which the motherboard might have a processor and a bus configured to pass data between the processor and peripherals, such as graphics processors or memories. Connectors may be mounted to the motherboard and connected to the bus. The peripherals may be implemented on daughtercards with connectors that mate with the connectors on the bus such that separately manufactured peripherals may be readily integrated into a computer made with the motherboard.

To enhance the availability of peripherals, the bus and the connectors used to physically connect peripherals via the bus may be standardized. In this way, there may be a large number of peripherals available from a multitude of manufacturers. All of those products, so long as they are compliant with the standard, may be used in a computer that has a bus compliant with the standard. Examples of such standards include serial ATA (SATA), serial attached SCSI (SAS), peripheral component interconnect express (PCIe), or SFF-8639, which are commonly used in computers. The standards have gone through multiple revisions over time, adapting to the higher performance requirements expected from computers.

### BRIEF SUMMARY

Aspects of the present application relate to high speed electrical connector and connector subassembly thereof.

Some embodiments relate to a shielding shell for an electrical connector configured to engage a mating component in a mating direction, the electrical connector comprising a plurality of groups of conductive elements, each conductive element comprising a mating end, a tail, and an intermediate portion joining the mating end and the tail. The shielding shell may comprise a plurality of first portions; a plurality of openings aligned in a row direction perpendicular to the mating direction, each of the plurality of openings disposed between adjacent first portions of the plurality of first portions such that the mating ends of a group of the plurality of groups of conductive elements are exposed through an opening of the plurality of openings; and a second portion joining the plurality of first portions, the second portion comprising a body and a plurality of contact arms curving away from the body and configured to contact a complementary conductive member of the mating component.

Optionally, the plurality of contact arms are aligned in the row direction; and each of the plurality of contact arms is aligned with a respective first portion of the plurality of first portions in the mating direction.

Optionally, the plurality of contact arms of the second portion are a plurality of second contact arms; and each of the plurality of first portions comprises a first contact arm aligned with a respective second contact arm of the plurality of second contact arms in the mating direction to form pairs of contact arms.

Optionally, for each pair of contact arms, the first contact arm and the second contact arm are spaced apart such that the first contact arm and the second contact arm contact the complementary conductive member of the mating component at different locations.

Optionally, each of the plurality of first contact arms comprises a first proximal end joined with a body of the respective first portion and a first distal end; each of the plurality of second contact arms comprises a second proximal end joined with the body of the second portion and a second distal end; and for each pair of contact arms, the first distal end of the first contact arm and the second distal end of the second contact arm are disposed between the first proximal end of the first contact arm and the second proximal end of the second contact arm.

Some embodiments relate to a connector subassembly. The connector subassembly may comprise an insulative member; a plurality of conductive elements held by the insulative member in a row direction and disposed in a plurality of groups of conductive elements, each conductive element comprising a mating end, a tail, and an intermediate portion joining the mating end and the tail, wherein the plurality of groups of conductive elements comprise a plurality of pairs of conductive elements; and for each pair of conductive elements, the mating ends are spaced apart from each other by a first center-to-center pitch in the row direction, the intermediate portions are spaced apart from each other by a second center-to-center pitch in the row direction, and the first center-to-center pitch is greater than the second center-to-center pitch.

Optionally, for each conductive element of the plurality of pairs of conductive elements, the mating end has a convexly curved shape and is narrower than the intermediate portion in the row direction.

Optionally, for each conductive element of the plurality of pairs of conductive elements, both the mating end and the intermediate portion are blade-shaped, and the mating end has a same width as the intermediate portion in the row direction; and each conductive element of the plurality of pairs of conductive elements comprises a transition portion between the mating end and the intermediate portion, the transition portion is curved in a vertical direction perpendicular to both the row direction and the mating direction.

Optionally, the connector subassembly further comprises a shielding shell comprising a plurality of first openings, wherein the intermediate portions of the plurality of conductive elements are disposed within the shielding shell such that the mating ends of the conductive elements in each group of the plurality of groups are exposed through a first opening of the plurality of first openings.

Optionally, the shielding shell comprises a plurality of first portions each disposed between adjacent groups of the plurality of groups; and each first portion of the plurality of first portions of the shielding shell is spaced apart from the mating end of an adjacent conductive element by the first center-to-center pitch in the row direction.

Optionally, the shielding shell comprises a plurality of first contact arms each curving away from a respective first portion of the plurality of first portions; and each first contact arm of the plurality of first contact arms is spaced apart from the mating end of the adjacent conductive element by the first center-to-center pitch in the row direction.

Optionally, the mating ends of the plurality of conductive elements comprise mating contact surfaces disposed in a first plane; and the plurality of first contact arms comprise mating contact surfaces disposed in a second plane offset from the first plane in a vertical direction perpendicular to both the row direction and the mating direction.

Optionally, the shielding shell comprises a second portion joining the plurality of first portions, and a plurality of second contact arms curving away from the second portion; and the plurality of first contact arms comprise mating contact surfaces disposed in the second plane.

Optionally, the shielding shell comprises a plurality of second openings; and the tails of the conductive elements in each group of the plurality of groups are exposed through a second opening of the plurality of second openings.

Optionally, the shielding shell comprises a first shell part comprising a plurality of plateaus, a plurality of valleys, and sides joining adjacent plateaus and valleys; and a second shell part comprising the plurality of first openings, wherein each valley of the plurality of valleys is disposed between adjacent groups of the plurality of groups; and the second shell part is attached to the first shell part at the plurality of valleys so as to form a plurality of tubular structures, each tubular structure comprising a plateau of the plurality of plateaus of the first shell, sides of the first shell joining the plateau to respective valleys, and a portion of the second shell part opposing the plateau of the first shell in the vertical direction.

Optionally, the first shell part further comprises a plurality of first flaps disposed between adjacent second openings of the plurality of second openings of the shielding shell so as to separate adjacent groups of the plurality of groups in the row direction; and adjacent first flaps that separate same adjacent groups of conductive elements in the row direction form a plurality of first flap pairs each configured to be connected to a same conductive pad of a circuit board.

Optionally, the tail of each conductive element comprises a first mounting contact surface; each first flap pair comprises a second mounting contact surface; and for each group of the plurality of groups of conductive elements, the tails of two adjacent conductive elements are spaced apart from each other by a third center-to-center pitch in the row direction, each first flap pairs is spaced apart from the tail of an adjacent conductive clement by a fourth center-to-center pitch in the row direction, and the fourth center-to-center pitch is equal to the third center-to-center pitch.

Optionally, the first shell part further comprises a plurality of second flaps; and each second flap extends from a plateau of the plurality of plateaus and joins two first flaps that correspond to a same tubular structure.

Some embodiments relate to an interconnection system. The interconnection system may comprise a pair of mating electrical connectors comprising a first connector and a second connector, each of the first connector and the second connector comprising an insulative member; a plurality of conductive elements held by the insulative member in a row direction and disposed in a plurality of groups of conductive elements, each conductive element comprising a mating end, a tail, and an intermediate portion joining the mating end and the tail; and a shielding shell comprising a plurality of openings, the intermediate portions of the plurality of conductive elements are disposed within the shielding shell such that the mating ends of the conductive elements in each group of the plurality of groups are exposed through an opening of the plurality of openings. The shielding shell of a first connector of the pair of mating electrical connectors may comprise a plurality of contact arms aligned with the intermediate portions of the plurality of conductive elements of the first connector, and positioned such that the plurality of contact arms contact the shielding shell of a second connector of the pair of mating electrical connectors at locations closer to a distal end of the shielding shell of the second connector than mating locations of the mating ends of the conductive elements of the pair of mating electrical connectors.

Optionally, the plurality of contact arms are a plurality of second contact arms; the shielding shell of the first connector of the pair of mating electrical connectors comprises a plurality of first contact arms aligned with the mating ends of the plurality of conductive elements of the first connector; and the plurality of groups of conductive elements of each of the pair of mating electrical connector comprises a plurality of pairs of conductive elements, and the mating ends of each pair of conductive elements are spaced farther apart from each other in the row direction than the respective intermediate portions.

Some embodiments relate to a connector subassembly. The connector subassembly may comprise a plurality of conductive elements each comprising a mating end, a tail opposite to the mating end, and an intermediate portion joining the mating end and the tail. The connector subassembly may comprise an insulative member holding the intermediate portions of the plurality of conductive elements such that the plurality of conductive elements are arranged in a row in which the plurality of conductive elements are disposed in a plurality of groups of conductive elements spaced apart from each other in a row direction, and the mating end of each conductive clement is oriented in a mating direction perpendicular to the row direction. The connector subassembly may comprise a shielding shell comprising a plurality of first openings and a plurality of pairs of contact arms, the shielding shell disposed around the plurality of conductive elements and the insulative member, such that the intermediate portions of the plurality of conductive elements and the insulative member are positioned within the shielding shell and such that the mating ends of each group of the plurality of groups of conductive elements are exposed through a corresponding one of the plurality of first openings, each pair of the plurality of pairs of contact arms disposed between corresponding two adjacent groups of the plurality of groups of conductive elements and to be adjacent to the mating ends of the corresponding two adjacent groups of conductive elements, and each pair of contact arms comprising a first contact arm and a second contact arm spaced apart from each other in the mating direction.

Optionally, for each pair of the plurality of pairs of contact arms: the first contact arm and the second contact arm each comprises a first end and a second end opposite to each other, the first end is configured to be fixed and the second end is configured to be unfixed; and the first contact arm and the second contact arm are arranged in the mating direction, such that the second end of the first contact arm and the second end of the second contact arm are opposed to each other in the mating direction, and such that the first end of the first contact arm and the first end of the second contact arm are opposite to each other in the mating direction.

Optionally, for each pair of the plurality of pairs of contact arms, the first contact arm is disposed between the mating ends of the corresponding two adjacent groups of conductive elements, and the second contact arm is disposed between portions of the intermediate portions of the corresponding two adjacent groups of conductive elements adjacent to the mating ends.

Optionally, for each pair of the plurality of pairs of contact arms, the second end of the first contact arm is spaced apart center-to-center from the mating end of an adjacent conductive clement by a first pitch in the row direction. For each group of the plurality of groups of conductive elements, the mating ends of two adjacent conductive elements are spaced apart center-to-center from each other by a second pitch in the row direction. The first pitch is equal to the second pitch.

Optionally, for each pair of the plurality of pairs of contact arms, the second end of the first contact arm has a first convexly curved shape with a first contact apex portion. The first contact apex portions of the second ends of the first contact arms of the plurality of pairs of contact arms are aligned in a first line parallel to the row direction and are coplanar in a first plane parallel to the row direction and the mating direction.

Optionally, for each pair of the plurality of pairs of contact arms, the second end of the second contact arm has a second convexly curved shape with a second contact apex portion. The second contact apex portions of the second ends of the second contact arms of the plurality of pairs of contact arms are aligned in a second line parallel to the row direction and are coplanar in the first plane, the second line and the first line are spaced apart from each other in the mating direction.

Optionally, for each conductive element, the mating end has a third convexly curved shape with a third contact apex portion. The third contact apex portions of the mating ends of the plurality of conductive elements are aligned in the first line and are coplanar in a second plane parallel to the row direction and the mating direction.

Optionally, the shielding shell comprises a plate-shaped body extending parallelly to the row direction and the mating direction, the plurality of first openings are provided on the plate-shaped body, the first ends of the first contact arms and the first ends of the second contact arms of the plurality of pairs of contact arms are connected to the plate-shaped body, and the second ends of the first contact arms and the second ends of the second contact arms of the plurality of pairs of contact arms protrude above an outer surface of the plate-shaped body. The first plane is at a first distance from the outer surface of the plate-shaped body in a vertical direction perpendicular to the row direction and the mating direction. The third contact apex portions of the mating ends of the plurality of conductive elements protrude above the outer surface of the plate-shaped body through a corresponding first opening, such that the second plane is at a second distance from the outer surface of the plate-shaped body in the vertical direction, the second distance is greater than the first distance.

Optionally, the shielding shell comprises a plate-shaped body extending parallelly to the row direction and the mating direction, the plurality of first openings are provided on the plate-shaped body, the first ends of the first contact arms and the first ends of the second contact arms of the plurality of pairs of contact arms are connected to the plate-shaped body, and the second ends of the first contact arms and the second ends of the second contact arms of the plurality of pairs of contact arms protrude above an outer surface of the plate-shaped body. For each conductive element, the mating end has a shape of a straight blade with a planar contact surface, and the planar contact surfaces of the mating ends of the plurality of conductive elements are coplanar with the outer surface of the plate-shaped body.

Optionally, the shielding shell comprises a plate-shaped body extending parallelly to the row direction and the mating direction, the plurality of first openings are provided on the plate-shaped body, the plate-shaped body further comprises a plurality of first portions each located between corresponding two adjacent first openings of the plurality of first openings in the row direction. For each pair of the plurality of pairs of contact arms, the first contact arm is a resilient arm cut out from a corresponding first portion of the plurality of first portions.

Optionally, the plate-shaped body further comprises a second portion extending above the intermediate portions of the plurality of conductive elements and joining the plurality of first portions. For each pair of the plurality of pairs of contact arms, the second contact arm is a resilient arm cut out from the second portion.

Optionally, for each pair of the plurality of pairs of contact arms, the first end of the first contact arm and the first end of the second contact arm are connected to the plate-shaped body, the plate-shaped body comprises a continuous slot extending between the first end of the first contact arm and the first end of the second contact arm, a portion of the slot between corresponding two adjacent first openings extends in a corresponding first portion of the plate-shaped body without being in communication with the corresponding two adjacent first openings.

Optionally, the plate-shaped body further comprises a front piece disposed beyond the mating ends of the plurality of conductive elements in the mating direction, the front piece joins the plurality of first portions, and the front piece extends in a vertical direction perpendicular to the row direction and the mating direction.

Optionally, for each conductive element, the intermediate portion extends from the mating end in the mating direction. The plurality of conductive elements comprise a plurality of pairs of signal conductive elements configured for carrying differential signals, the signal conductive elements of each pair of signal conductive elements are adjacent to each other in the row direction, with the mating ends thereof exposed through the same first opening. The mating ends of each pair of signal conductive elements are spaced apart center-to-center from each other by a second pitch in the row direction, and the intermediate portions of each pair of signal conductive elements are spaced apart center-to-center from each other by a third pitch in the row direction, the second pitch is greater than the third pitch.

Optionally, for each conductive element, the mating end has a convexly curved shape to protrude out of the shielding shell. For each pair of signal conductive elements, the mating ends each have a first width in the row direction, and the intermediate portions each have a second width in the row direction, the first width is less than the second width.

Optionally, each conductive element comprises edges and broadsides joined by the edges, and the plurality of conductive elements are arranged in a row in an edge-to-edge manner. For each signal conductive element, the broadsides of the mating end and the broadsides of the intermediate portion are planar and have the same widths, and each signal conductive element includes a transition portion between the mating end and the intermediate portion, the transition portion is curved in a vertical direction perpendicular to the row direction and the mating direction, such that the broadside of the mating end and the broadside of the intermediate portion extend in two different planes perpendicular to the vertical direction, and the transition portion is curved in the row direction, such that a center line of the mating end is offset from a center line of the intermediate portion in the mating direction. For each pair of signal conductive elements, the transition portion of each signal conductive element is curved away from the transition portion of the other signal conductive element in the row direction.

Optionally, the shielding shell comprises: a first shell part comprising a plurality of plateaus, a plurality of valleys, and sides joining adjacent plateaus and valleys. A second shell part comprising the plurality of first openings and the plurality of pairs of contact arms. Each of the plurality of valleys is located between corresponding two adjacent groups of the plurality of groups of conductive elements, the second shell part is attached to the first shell part at the plurality of valleys, and is opposed to the plurality of plateaus in a vertical direction perpendicular to the row direction and the mating direction, so as to enclose a tubular structure with each plateau and two corresponding sides, the intermediate portions of a corresponding group of conductive elements are received in the tubular structure.

Some embodiments relate to a connector subassembly. The connector subassembly may comprise: a plurality of conductive elements each comprising a mating end, a tail opposite to the mating end, and an intermediate portion joining the mating end and the tail. A connector subassembly may comprise an insulative member holding the intermediate portions of the plurality of conductive elements such that the plurality of conductive elements are arranged in a row in which the plurality of conductive elements are disposed in a plurality of groups of conductive elements spaced apart from each other in a row direction, and the mating end of each conductive element is oriented in a mating direction perpendicular to the row direction, the intermediate portion extending from the mating end in the mating direction. A connector subassembly may comprise a shielding shell comprising a plurality of first openings, the shielding shell disposed around the plurality of conductive elements and the insulative member such that the intermediate portions of the plurality of conductive elements and the insulative member are located within the shielding shell and such that the mating ends of each group of the plurality of conductive elements are exposed through a corresponding one of the plurality of first openings. The plurality of groups of conductive elements may comprise a plurality of pairs of signal conductive elements configured for carrying differential signals, signal conductive elements of each pair of signal conductive elements are adjacent to each other in the row direction, with the mating ends thereof exposed through the same first opening, wherein the mating ends of each pair of signal conductive elements are spaced apart center-to-center from each other by a first pitch in the row direction, and wherein the intermediate portions of each pair of signal conductive elements are spaced apart center-to-center from each other by a second pitch in the row direction, the first pitch is greater than the second pitch.

Optionally, for each conductive element, the mating end has a convexly curved shape to protrude out of the shielding shell. For each pair of signal conductive elements, the mating ends each have a first width in the row direction, and the intermediate portions each have a second width in the row direction, the first width is less than the second width.

Optionally, each conductive element comprises edges and broadsides joined by the edges, and the plurality of conductive elements are arranged in a row in an edge-to-edge manner. For each signal conductive element, the broadsides of the mating end and the broadsides of the intermediate portion are planar and have the same widths, and each signal conductive element includes a transition portion between the mating end and the intermediate portion, the transition portion is curved in a vertical direction perpendicular to the row direction and the mating direction, such that the broadside of the mating end and the broadside of the intermediate portion extend in two different planes perpendicular to the vertical direction, and the transition portion is curved in the row direction, such that a center line of the mating end is offset from a center line of the intermediate portion in the mating direction. For each pair of signal conductive elements, the transition portion of each signal conductive element is curved away from the transition portion of the other signal conductive element in the row direction.

Optionally, the shielding shell comprises a plurality of shell mating ends each disposed between corresponding two adjacent groups of the plurality of groups of conductive elements and to be adjacent to the mating ends of the corresponding two adjacent groups, each shell mating end is spaced apart center-to-center from the mating end of the adjacent conductive clement by the first pitch in the row direction.

Optionally, for the shielding shell, the plurality of shell mating ends comprise mating contact surfaces disposed to be coplanar with an outer surface of the shielding shell, and for the plurality of conductive elements, the mating ends comprise mating contact surfaces disposed to be coplanar with the outer surface of the shielding shell.

For the shielding shell, the plurality of shell mating ends comprise mating contact surfaces disposed to be coplanar in a first plane located above and parallel to the outer surface of the shielding shell, and for the plurality of conductive elements, the mating ends comprise mating contact surfaces disposed to be coplanar with the outer surface of the shielding shell.

Optionally, each shell mating end comprises a first resilient contact arm and a second resilient contact arm spaced apart from each other in the mating direction, the first resilient contact arm and the second resilient contact arm each comprise a first end and a second end opposite to each other, the first end is configured to be fixed and the second end is configured to be unfixed, the first resilient contact arm and the second resilient contact arm are arranged in the mating direction, such that the second end of the first resilient contact arm and the second end of the second resilient contact arm are opposed to each other in the mating direction, and such that the first end of the first resilient contact arm and the first end of the second resilient contact arm are opposite to each other in the mating direction.

Optionally, the shielding shell comprises: a first shell part comprising a plurality of plateaus, a plurality of valleys, and sides joining adjacent plateaus and valleys; and a second shell part comprising the plurality of first openings. Each of the plurality of valleys is located between corresponding two adjacent groups of the plurality of groups of conductive elements, the second shell part is attached to the first shell part at the plurality of valleys, and is opposed to the plurality of plateaus in a vertical direction perpendicular to the row direction and the mating direction, so as to enclose a tubular structure with each plateau and two corresponding sides, the intermediate portions of a corresponding group of conductive elements are received in the tubular structure.

Optionally, each tubular structure comprises a first end and a second end opposite to each other, the first end of the tubular structure is in communication with a corresponding one of the plurality of first openings so as to expose the mating ends of the corresponding group of conductive elements through the corresponding first opening, and the tubular structure defines a second opening at the second end, the mating ends of the corresponding group of conductive elements are exposed through the second opening The first shell part further comprises a plurality of first flaps each extending from a corresponding side of the first shell part to a position between corresponding two adjacent groups of conductive elements at the second opening of the tubular structure, such that the corresponding two adjacent groups of conductive elements are separated by two first flaps in the row direction.

Optionally, the two first flaps separating the corresponding two adjacent groups of conductive elements in the row direction are configured to be connected to the same conductive pad or the same conductive through hole of a circuit board.

Optionally, the two first flaps are engaged with each other to form a single mounting portion, or the two first flaps are spaced apart from each other in the row direction. The tail of each conductive element comprises a first mounting contact surface, and each first flap comprises a second mounting contact surface, the first mounting contact surface and the second mounting contact surface are coplanar. For each group of the plurality of groups of conductive elements, the tails of two adjacent conductive elements are spaced apart center-to-center from each other by a fourth pitch in the row direction, the two first flaps as a whole are spaced apart center-to-center from the tail of an adjacent conductive element by a fifth pitch in the row direction, the fourth pitch is equal to the fifth pitch.

The first shell part further comprises a plurality of second flaps, each second flap extends from a corresponding plateau and joins two first flaps corresponding to the same tubular structure, the second shell part further comprises a plurality of rear pieces, each rear piece forms an annular portion with the two first flaps and one second flap corresponding to the same tubular structure to surround the tails of a corresponding group of conductive elements.

The first shell part comprises a plurality of subparts each comprising at least one plateau, at least two sides, and at least a portion of at least one valley, the plurality of subparts are connected to each other at the valleys.

Optionally, the electrical connector may comprise: an insulative housing comprising a base portion, and a tongue portion extending from the base portion and having a first side and a second side opposite to each other; and the aforementioned connector subassembly, wherein the connector subassembly is disposed on the first side of the tongue portion.

Optionally, the tongue portion includes a platform on the second side; and the electrical connector further comprises a plurality of conductive elements disposed on the second side of the tongue portion.

Optionally, an electrical connector may comprise: an insulative housing comprising a slot having a first side and a second side opposed to each other; and the aforementioned connector subassembly, wherein the connector subassembly is disposed within the insulative housing, such that the mating ends of the connector subassembly are lined on the first side of the slot.

Optionally, the slot of the insulative housing comprises a recess on the second side. The electrical connector further comprises a plurality of conductive elements, wherein the plurality of conductive elements comprises mating ends lined on the second side of the slot.

These techniques may be used alone or in any suitable combination. The foregoing summary is provided by way of illustration and is not intended to be limiting.

### BRIEF DESCRIPTION OF THE DRAWINGS

The accompanying drawings may not be drawn to scale. In the drawings, each identical or nearly identical component that is illustrated in various figures may be represented by a like numeral. For purposes of clarity, not every component may be labeled in every drawing. In the drawings:

FIG. 1A is a top, front perspective view of a plug connector, showing a top row of conductive elements, according to some embodiments;

FIG. 1B is a bottom, front perspective view of the plug connector of FIG. 1A, showing a bottom row of conductive elements;

FIG. 1C is a partially exploded top perspective view of the plug connector of FIG. 1A;

FIG. 1D is a partially exploded bottom perspective view of the plug connector of FIG. 1A;

FIG. 2A is a top, rear perspective view of a connector subassembly of the plug connector of FIG. 1A;

FIG. 2B is a bottom, rear perspective view of the connector subassembly of FIG. 2A;

FIG. 2C is a bottom, front perspective view of the connector subassembly of FIG. 2A;

FIG. 2D is a bottom view of the connector subassembly of FIG. 2A;

FIG. 2E is a partially exploded top perspective view of the connector subassembly of FIG. 2A;

FIG. 2F is a partially exploded bottom perspective view of the connector subassembly of FIG. 2A;

FIG. 3 is an enlarged top view of the area 3 circled by the dashed box in FIG. 2F, showing two groups of conductive elements and corresponding portions of an insulative member of the connector subassembly;

FIG. 4A is a cross sectional perspective view along the line labeled as “4A-4A” in FIG. 2D;

FIG. 4B is an enlarged top view of the area 4B circled by the dashed box in FIG. 4A;

FIG. 4C is a cross sectional perspective view along the line labeled as “4C-4C” in FIG. 2D;

FIG. 4D is an enlarged top view of the area 4D circled by the dashed box in FIG. 4C;

FIG. 5A is a perspective view of the rightmost three subparts of a first shell part of a shielding shell of the connector subassembly of FIG. 2F in an assembled state;

FIG. 5B is a perspective view of the three subparts of FIG. 5A in an exploded state;

FIG. 6A is a top, front perspective view of a receptacle connector including a connector subassembly, showing a mating interface, according to some embodiments;

FIG. 6B is a bottom, rear perspective view of the receptacle connector of FIG. 6A, showing the mounting interface;

FIG. 6C is a partially exploded top perspective view of the receptacle connector of FIG. 6A;

FIG. 6D is another partially exploded top perspective view of the receptacle connector of FIG. 6A;

FIG. 7A is a top, rear perspective view of a connector subassembly of the receptacle connector of FIG. 6A;

FIG. 7B is a top, front perspective view of the connector subassembly of FIG. 7A;

FIG. 7C is a bottom, front perspective view of the connector subassembly of FIG. 7A;

FIG. 7D is a bottom, rear perspective view of the connector subassembly of FIG. 7A;

FIG. 7E is a top view of the connector subassembly of FIG. 7A;

FIG. 7F is a front view of the connector subassembly of FIG. 7A;

FIG. 7G is a partially exploded top perspective view of the connector subassembly of FIG. 7A;

FIG. 7H is a partially exploded bottom perspective view of the connector subassembly of FIG. 7A;

FIG. 8 is a cross sectional perspective view along the line labeled as “8-8” in FIG. 7C;

FIG. 9 is an enlarged top view of the area 9 circled by the dashed box in FIG. 7G, showing two groups of conductive elements and corresponding portions of the insulative member of the connector subassembly;

FIG. 10A is a perspective view of the rightmost three subparts of the first shell part of a shielding shell of the connector subassembly of FIG. 7G in an assembled state;

FIG. 10B is a perspective view of the three subparts of FIG. 10A in an exploded state;

FIG. 11A is a performance plot showing the near-end crosstalk (NEXT) of the receptacle connector of FIG. 6A as a function of frequency; and

FIG. 11B is a performance plot showing the NEXT of the plug connector of FIG. 1A as a function of frequency.

### DETAILED DESCRIPTION

The inventors have recognized and appreciated connector design techniques that satisfy electrical and mechanical requirements to support greater bandwidth through high frequency operation. Some of these techniques may synergistically support higher frequency connector operation, satisfy the physical requirements set by industry standards such as PCleSAS, and meet requirements for mass manufacturing, including cost, time and reliability. A connector satisfying the mechanical requirements of the PCIESAS specification at the performance required for GEN 6 and beyond is used as an example of a connector in which these techniques have been applied.

According to aspects of the present disclosure, mating electrical connectors may have shielding shells around conductive elements that may serve as signal conductors, with openings in the shielding shells exposing mating portions of the conductive elements. When the connectors are mated, the conductive elements in the connectors may contact one another at their mating portions. The shielding shells of the mated connectors also may contact one another. The features of the shielding shells that provide that contact may enable higher bandwidth of the connector, such as by reducing crosstalk. In some examples, a shielding shell of at least one of the mating connectors may have interconnected portions with contact portions to provide multiple points of contact between adjacent openings exposing the mating portions of the conductive elements. In some examples, the contact portions may be contact arms that may be stamped from an integral sheet of metal forming a shielding shell on at least one side of the connector.

In some examples, there may be a pair of contact arms. The contact arms of one connector may extend in opposite directions so as to make contact at different distances from the distal edge of the shielding shell of a mating connector. In some examples, those points of contact may be along a line generally parallel to a mating direction of the two connectors and may similarly be between opening exposing the mating portions of the conductive elements of the mating connector.

The configuration of the contact portions may impact ground current flow within the shielding shell in the vicinity of the conductive elements carrying signals, such as high speed signals, which may in turn reduce crosstalk.

In some examples, an electrical connector may include a subassembly having one or more rows of conductive elements held in groups by an insulative member. The conductive elements may each have a mating end comprising a mating contact surface, configured for mating with a complementary mating contact surface of a mating component (e.g., a circuit board, a complementary connector). Each conductive element may also have a tail comprising a mounting contact surface, configured for mounting the connector to another electrical component (e.g., a circuit board, a cable). Each conductive element may also have an intermediate portion, joining the mating end and the tail.

The conductive elements may include pairs of signal conductors configured for carrying differential signals. Signal conductors of each pair may be disposed adjacent to each other in the row direction. The mating ends of each pair of signal conductive elements may be spaced apart from each other by a first center-to-center pitch in the row direction, and the intermediate portions of each pair of signal conductive elements may be spaced apart from each other by a second center-to-center pitch in the row direction. The first center-to-center pitch may be greater than the second center-to-center pitch. Such a configuration may improve impedance consistency along the signal transmission paths, reducing crosstalk and improving signal integrity.

The connector subassembly may include a shielding shell configured to provide multi-dimensional shielding for conductors in each of the multiple groups. The shielding shell may provide shielding over at least a portion of the lengths of the conductors and may provide shielding substantially along the lengths of the conductors.

The shielding shell may have contact members. In some embodiments, the contact members may be integrally formed with the one or more sheets formed into the shielding shell or may be separately formed and electrically and/or mechanically connected to those one or more sheets.

The contact members of the shielding shell may include shell mating ends. The shell mating ends may extend from a body (e.g., a planar body) of the shielding shell. In some embodiments, the shell mating ends of the shielding shell may extend parallelly to mating ends of conductive elements. Each shell mating end may be disposed between adjacent groups of conductive elements. Each shell mating end may have a mating contact surface configured for contacting a complementary conductive member of a mating component. In some embodiments, each shell mating end may include a first contact arm configured to contact the complementary conductive member of the mating component.

The contact members may include a second portion joining the shell mating ends. The second portion may include the body and second contact arms extending from the body and configured to contact the complementary conductive member of the mating component. The contact arms may contact the complementary shielding shell at locations closer to a distal end of the complementary shielding shell than the conductor mating ends. Such a configuration may provide an improved shielding.

In some embodiments, the first and second contact arms may include a plurality of pairs of contact arms. Each pair of contact arms may be disposed between adjacent groups of a plurality of groups of conductive elements and adjacent to the mating ends of the adjacent groups of conductive elements. Each pair of contact arms may include a first contact arm and a second contact arm spaced apart from each other in the mating direction. Such a configuration may enable a dual ground connection at the same shell mating end, which may provide reliable shielding along the signal transmission path and to reduce crosstalk, improving signal integrity.

Each contact arm may include a proximal end and a distal end. The proximal end may be joined with the body of the shielding shell. The second end may be a free end. The first contact arm and the second contact arm may be arranged in the mating direction such that the distal end of the first contact arm and the distal end of the second contact arm may be opposed to each other in the mating direction. Such a configuration may enable a reliable ground connection and reduce crosstalk.

In some embodiments, the shielding shell may include flaps having tails with mounting contact surfaces. The tails of the shielding shell may be in line with the tails of the conductive elements in the row direction. The tails of the shielding shell may be shaped similar to those of the tails of the conductive elements. Such a configuration may enable the tails of the shielding shell to be mounted to a PCB at the same time and using the same attachment technology as the conductive elements. Both the conductive elements and the shielding shell, for example, may be mounted to a PCB using surface mount soldering. The mounting contact surfaces of the flaps of the shielding shell may be coplanar with the mounting contact surfaces of the conductive elements, which may facilitate mounting the connector on another electrical component, such as through surface mount soldering.

In some embodiments, the shielding shell may surround on four sides the intermediate portions of the signal conductors in each group and may extend from the mating ends to tails of the signal conductors, with openings that expose contact surfaces at the mating and tails. For example, a shielding shell may be formed by shaping one or more metal sheets into multiple tubular structures connected to each other, with a group of conductive elements extending through a hollow interior of a corresponding tubular structure. Each tubular structure may have conductive walls bounding the intermediate portions of the conductive elements in one group, on at least three sides. In some embodiments, each tubular structure may bound the intermediate portions of a corresponding group of conductive elements on four sides. At the ends, each tubular structure may also bound the mating and tails of the corresponding group of conductive elements on at least three sides. In some embodiments, each tubular structure may bound the mating and tails of the conductive elements in a corresponding group on four sides. On at least one side, the mating and tails may be exposed through the shielding shell for mating to a complementary connector or mounting to a PCB.

In some embodiments, the row of conductive elements may include conductive elements configured for high-speed signals, low-speed signals, ground, power, or any other suitable purposes. In some embodiments, the row of conductive elements may be a first row of conductive elements. The electrical connector may include a second row of conductive elements. The high-speed and low-speed signal conductors, as well as conductive elements configured for other purposes, may be distributed across the rows. One or more other rows of the connector may include shielding shells providing shielding around at least the high-speed signal conductors of the other rows. Alternatively, the high-speed signal conductors may be only within a first row, for example, and only that row may include one or more shielding shells.

The rows of signal conductors may be held within a connector housing to mate with complementary signal conductors in a mating component. All or a portion of a row of conductive elements may be inserted into an opening in the connector housing as part of a subassembly, such as the subassembly described above comprising a shielding shell and a lead assembly. The design techniques described herein may be embodied as a receptacle connector. In those embodiments, the first and second rows of conductive elements may be separated by a slot, which may be configured to receive a mating end of another electrical component, such as a printed circuit board or a plug connector. Alternatively or additionally, the design techniques described herein may be embodied as a plug connector. In those embodiments, the first and second rows of conductive elements may be held on opposite sides of a housing wall, which may be configured to be inserted into a slot of another electrical component, such as a card edge connector or a receptacle connector.

Some embodiments of the present application will be described in detail below in conjunction with the accompanying drawings. It should be appreciated that these embodiments are not meant to form any limitations to the present application. Moreover, features in the embodiments of the present application may be combined with each other without conflict.

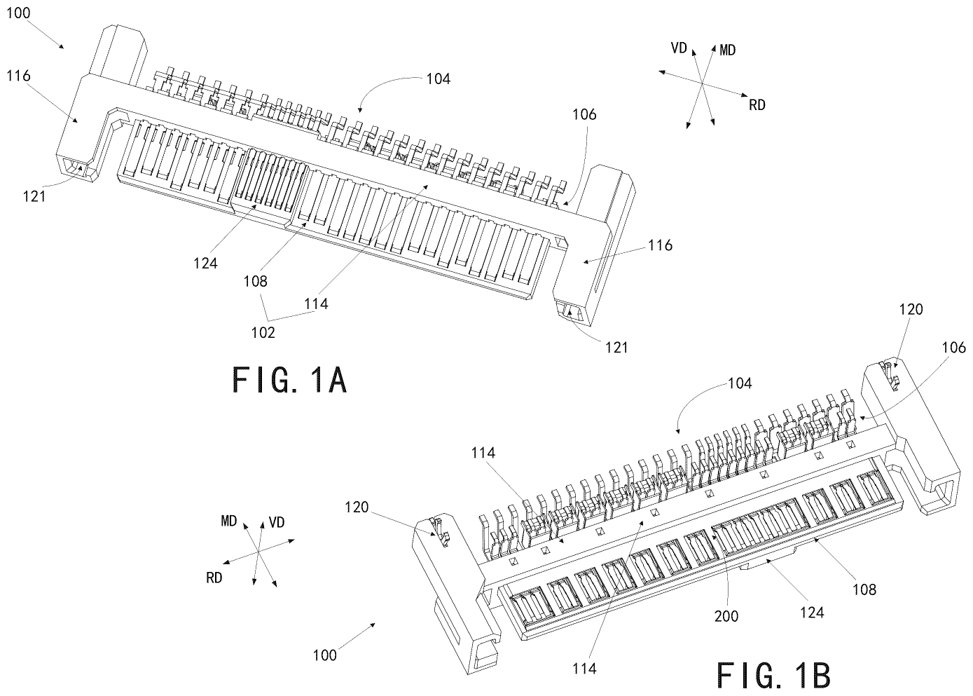

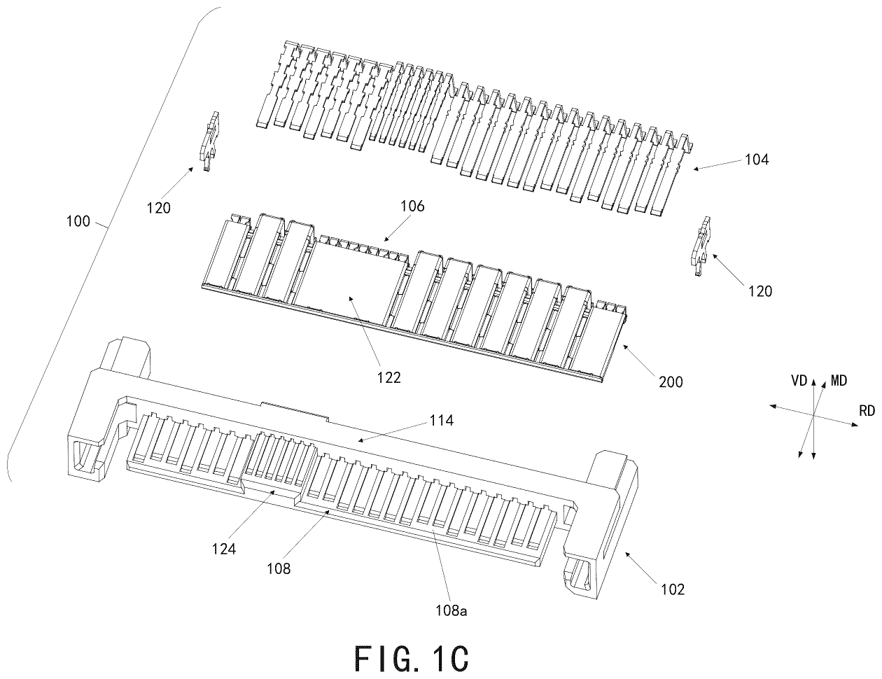

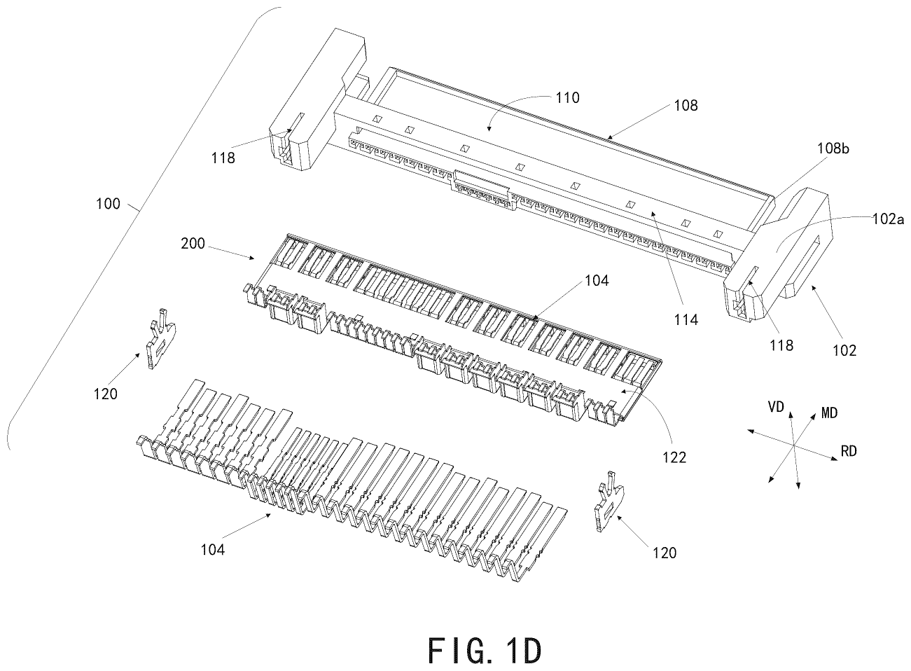

FIGS. 1A to 1D are an example of techniques as described herein integrated into the electrical connector 100. In the illustrated example, the electrical connector 100 may be configured as a plug connector, such as a plug connector compliant with the SSF-8639 standard, to be combined with a mating receptacle connector (such as the receptacle connector 500 to be described below) to constitute an electrical connector assembly. Such an electrical connector assembly can provide an industry-standard interface such as SFF-8639 to establish an electrical connection between a storage drive (such as a hard disk drive (HDD), a solid state drive (SSD), an optical disk drive (ODD), or the like) and a circuit board (such as a backplane, a midplane, a driver carrier board, or the like). The receptacle connector may be mounted to the circuit board, and the plug connector 100 may connect the storage drive to the receptacle connector, whereby the receptacle connector can establish an electrical connection between the circuit board and the plug connector 100, and the plug connector 100 can establish an electrical connection between the storage drive and the receptacle connector. In this way, the electrical connector assembly composed of the plug connector 100 and the receptacle connector can establish an electrical connection between the storage drive and the circuit board.

In the illustrated example, the plug connector 100 may include an insulative housing 102, which may include a base portion 114 that may elongate in a row direction RD, a tongue portion 108 extending from the base portion 114, and guide members 116 that may extend at opposite sides of the base portion 114. The guide members 116 may each include an opening 121 configured to receive a complementary guide member of a mating electrical component, and a slot 118 that may hold a fork lock 120. The fork lock 120 may be used to hold a mounting surface 102a of the housing 102 (shown in FIG. 1D) to a circuit board (e.g., a circuit board of a storage drive) to which the plug connector 100 is to be mounted.

The tongue portion 108 may include channels 110 shaped and configured to receive respective conductive elements. The connector 100 may include a top row 104 of conductive elements and a bottom row 106 of conductive elements, separated from each other by the tongue portion 108 of the housing 102. The tongue portion 108 may include a first side 108a and a second side 108b opposite to each other. As shown, the top row 104 of conductive elements may include conductive elements that may be shaped differently for various purposes including, for example, signal, ground, power, or any suitable purposes. Ground conductors, for example, may be longer than signal conductors. In some embodiments, conductors designated for carrying power may be wider than those designated for carrying signals. In the illustrated example, the top row 104 contains only low-speed signal conductors. The top row 104 may be disposed along the first side 108a of the tongue portion 108, which may have a platform 124 to distinguish from the second side 108b of the tongue portion 108 that may hold the bottom row 106. The bottom row 106 of conductive elements may also include conductive elements that may be shaped differently for various purposes including, for example, signal, ground, power, or any suitable purposes. The bottom row 106 contains groups of signal conductors configured for high-speed signals.

The connector 100 may include, in one or more rows, connector subassemblies configured to reduce crosstalk and enable high-speed transmission. In the illustrated example, the bottom row 106 of conductive elements and its associated shielding shell 122 form a connector subassembly 200. Each connector subassembly 200 may include one or more features to engage the connector housing 102 such that each subassembly 200 may be inserted into and then retained in the housing 102. In the illustrated example, each subassembly 200 may be retained within the housing 102 by being sized and shaped to fit in the channel 110. The channel 110 may be located at the second side 108b of the tongue portion 108.

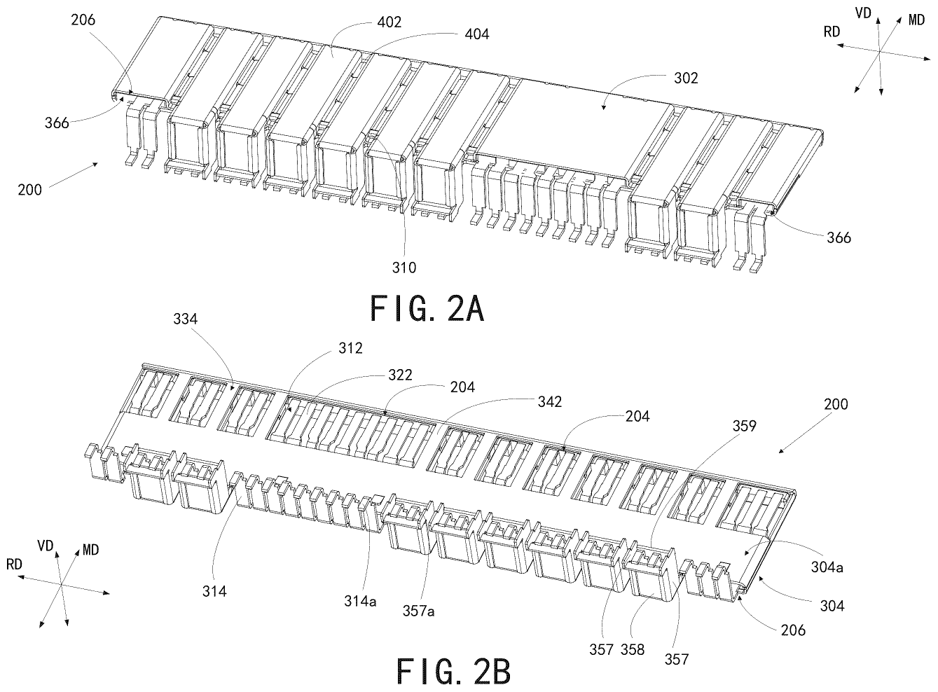

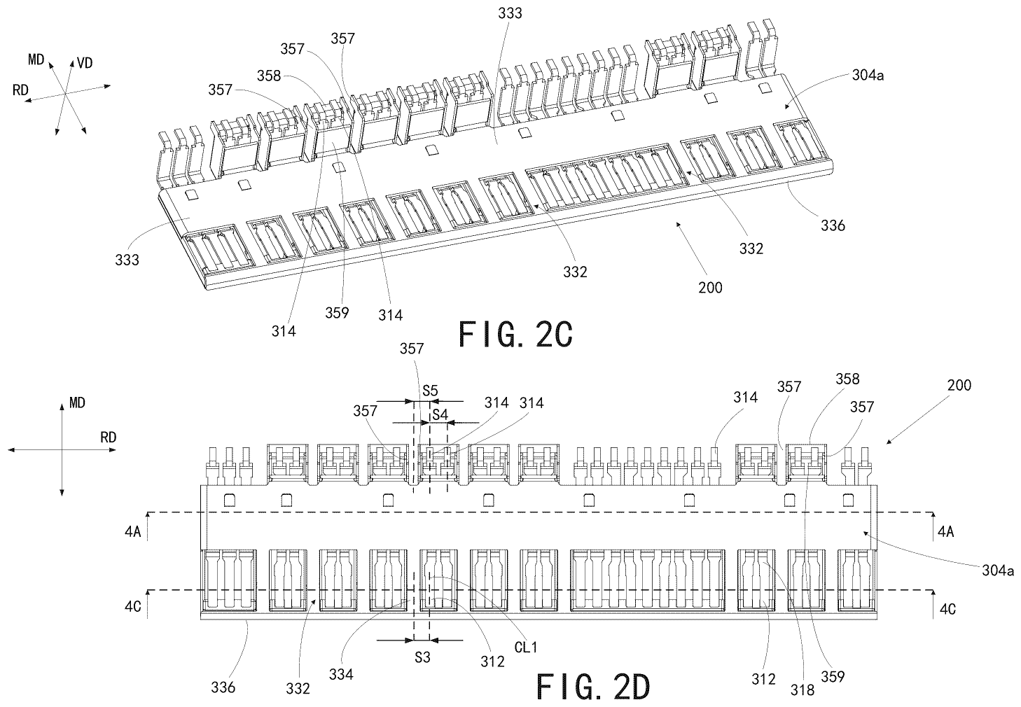

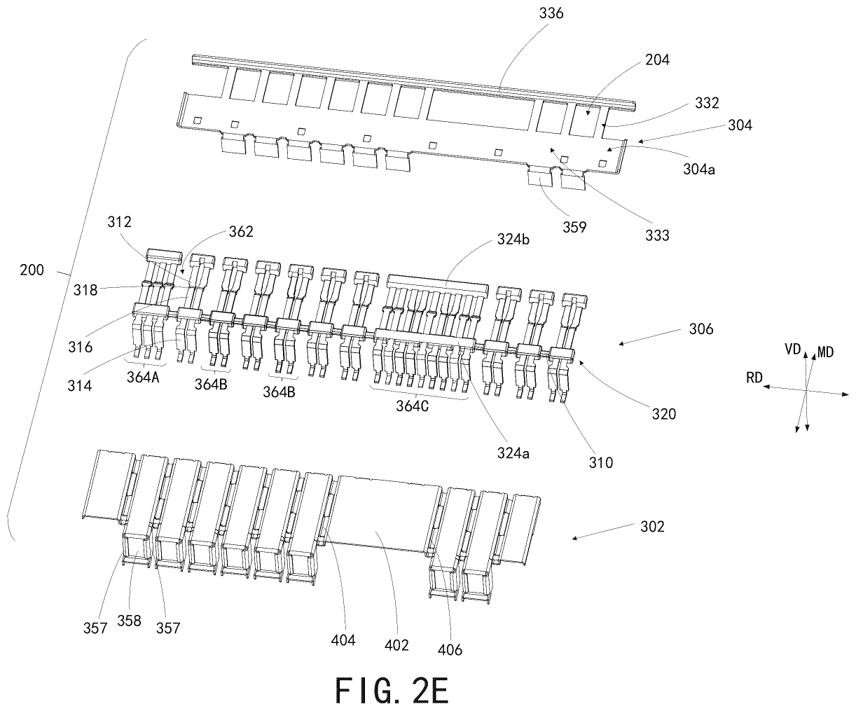

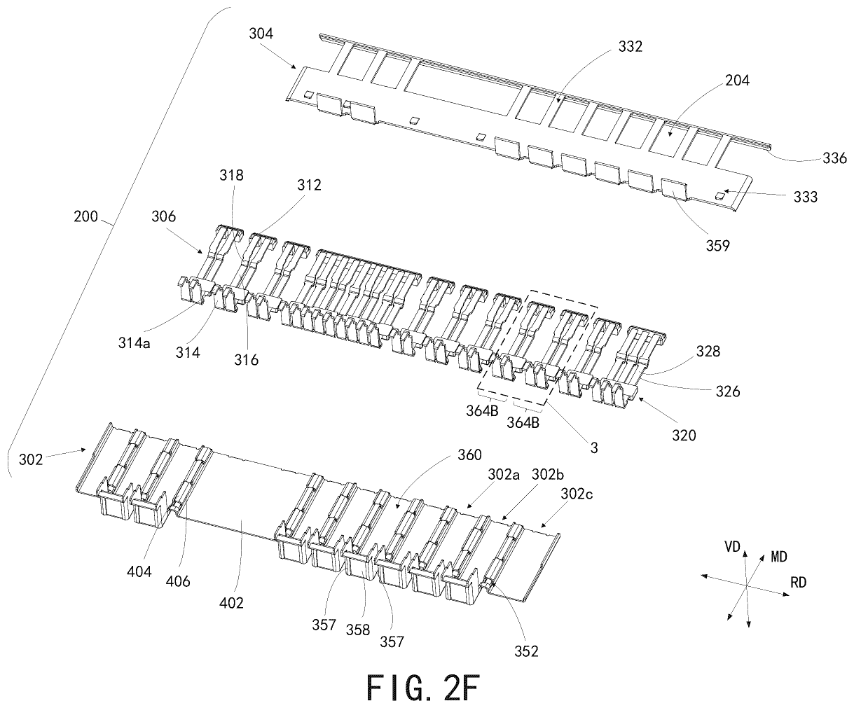

In the example shown in FIGS. 2A to 5B, the connector subassembly 200 may include the shielding shell 122 and a lead assembly 306. The lead assembly 306 may include a plurality of conductive elements 362. The conductive elements 362 may be configured as signal conductors. Each conductive element 362 includes a mating end 312, a tail 314 opposite to the mating end 312, and an intermediate portion 316 joining the mating end 312 and the tail 314. The intermediate portion 316 extends between the mating end 312 and the tail 314. The mating end 312 has a mating contact surface 322. Each conductive element 362 includes edges 326 and broadsides 328 joined by the edges 326. The mating end 312 may have a straight blade shape and the mating contact surface 322 may be planar. The broadsides 328 of the mating end 712 and the broadsides 328 of the intermediate portion 716 may be planar and may have the same widths. The mating contact surface 322 of the mating end 312 is provided on the broadside 328 of the mating end 312. For each conductive element 362, the intermediate portion 316 extends from the mating end 312 in the mating direction MD.

The lead assembly 306 may also include an insulative member 320 for holding the plurality of conductive elements 362. The insulative member 320 may hold at least the intermediate portions 316 of the plurality of conductive elements 362, such that the plurality of conductive elements 362 are arranged in a row. The row extends along a row direction RD. In the row, the plurality of conductive elements 362 may be arranged in an edge-to-edge manner, and the plurality of conductive elements 362 may be disposed as a plurality of groups of conductive elements 362 spaced apart from each other along the row direction RD. The row direction RD is perpendicular to the mating direction MD. The mating end 312 of each conductive element 362 is oriented along the mating direction MD. Each conductive element 362 may also include a transition portion 318 between the mating end 312 and the intermediate portion 316. The transition portion 318 is bent in a vertical direction VD perpendicular to the row direction RD and the mating direction MD, such that the broadside of the mating end 312 and the broadside of the intermediate portion 316 extend along two different planes that are perpendicular to the vertical direction VD. These two planes may be offset from each other in the vertical direction VD. The broadside of the mating end 312 and the broadside of the intermediate portion 316 may be offset from each other in the vertical direction VD.

The conductive elements 362 may be disposed in groups based on terminal assignments of a desired standard. In the illustrated example, the conductive elements 362 are disposed into three different kinds of groups 364A, 364B, and 364C. Each kind of groups may include different numbers of conductive elements 362. The insulative member 320 may include first holding portions 324a and second holding portions 324b that hold the conductive elements 362 in one group in an edge-to-edge configuration. The insulative member 320 may also include connecting portions 310 that connect the adjacent holding portions 324a. The holding portion 324a of the insulative member 320 may hold portions of the intermediate portions 316 of the conductive elements 362 in one group, and the holding portion 324b of the insulative member 320 may hold portions (such as distal ends) of the mating ends 312 of the conductive elements 362 in one group. In some embodiments, the mating end 312 of each conductive element 362 may have a distal end embedded in the holding portion 324b of the insulative member 320. The portions of the intermediate portions 316 held by the insulative member 320 may be along less than 50% of the lengths of the conductive elements 362, and in some embodiments, less than 40%, 30%, 20%, or 10% of the lengths of the conductive elements 362. This configuration may reduce impedance variation along the lengths of the conductive elements 362.

The shielding shell 122 may be configured with tubular structures 366 that each provides multi-dimensional shielding for one group of conductive elements 362, and shell mating ends (here shown as contact bars) 334 enabling the plug connector 100 to be compatible to physical requirements of corresponding industry standards. Such a configuration enables high-speed transmission, without the need to redesign mating electrical components such as the peripherals that may be designed and manufactured by different companies according to a standard that specifies locations of the mating and mounting contact surfaces. As shown, the shielding shell 122 may extend from the mating ends 312 to the tails 314 of the conductive elements 362. The shielding shell 122 may have a front piece 336 disposed beyond the mating ends 312 of the conductive elements 362. The shielding shell 122 may have a plurality of first openings 204 and a plurality of second openings 206. The shielding shell 122 may be disposed around the plurality of conductive elements 362 and the insulative member 320, such that the intermediate portions 316 of the plurality of conductive elements 362 and the insulative member 320 are located within the shielding shell 122, and such that the mating ends 312 of each group of the plurality groups of conductive elements 362 are exposed through a corresponding one of the plurality of first openings 204, and such that the tails 314 of each group of the plurality groups of conductive element 362 are exposed through a corresponding one of the plurality of second openings 206. In the illustrated example, the mating ends 312 of the conductive elements 362 are exposed through openings 204 in the shielding shell 122 that open in a direction (e.g., the vertical direction VD) perpendicular to the elongated dimension of the conductive elements 362.

The shielding shell 122 may include one or more shell parts. In the illustrated example, the shielding shell 122 includes a first shell part 302 and a second shell part 304 configured to be attached to the first shell part 302 to form the tubular structures 366 each substantially surrounding the conductive elements 362 in one group.

In some embodiments, the first shell part 302 may include a plurality of plateaus 402, a plurality of valleys 404, and sides 406 joining adjacent plateaus 402 and valleys 404. Each plateau 402 and the corresponding two sides 406 may form a channel 360. Each channel 360 is configured to receive at least the intermediate portions 316 of a corresponding group of conductive elements 362. The plateaus 402 extends at least from the distal ends of the mating ends 312 of the corresponding group of conductive elements 362 to the holding portion 324a of the insulative member 320. The second shell part 304 includes the plurality of first openings 204 as described above.

The second shell part 304 may be attached to the first shell part 302 at the plurality of valleys 404 and may be opposed to the plurality of plateaus 402 in the vertical direction VD perpendicular to the row direction RD and the mating direction MD to enclose the tubular structure with each plateau 402 and the corresponding two sides 406. The second shell part 304 may close the one side left open by the channel 360 and provide shielding on this side. The intermediate portions 316 of a corresponding group of conductive elements 362 are received in the tubular structure 366. Each of the plurality of valleys 404 is disposed between corresponding two adjacent groups of the plurality of groups of conductive elements 362.

Each tubular structure 366 includes a first end and a second end opposite to each other. The first end of the tubular structure 366 is in communication with a corresponding one of the plurality of first openings 204 to allow the mating end 312 of a corresponding group of conductive elements 362 to be exposed through the corresponding first opening 204. The tubular structure 366 defines a second opening 206 at the second end, and the tails 314 of the corresponding group of conductive elements 362 are exposed through the second opening 206.

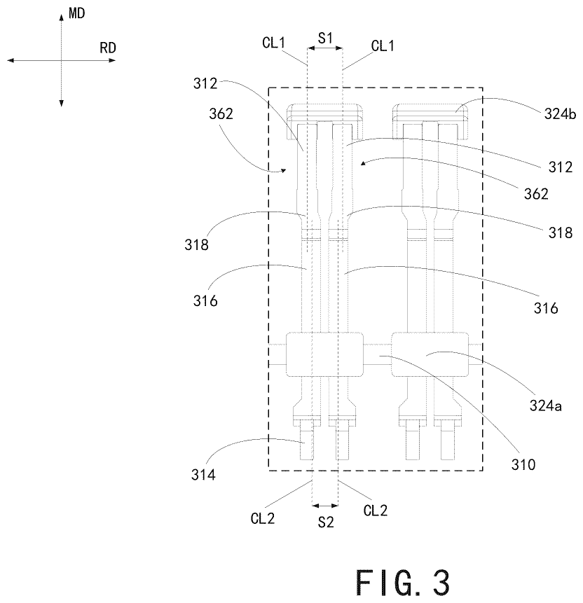

The plurality of groups of conductive elements 362 may include a plurality of pairs of signal conductive elements 362 (e.g., the group 364B) configured for carrying differential signals. FIG. 3 illustrates two pairs of signal conductive elements 362 for carrying differential signals. The signal conductive elements 362 of each pair of signal conductive elements 362 are adjacent to each other in the row direction RD with the mating ends 312 thereof exposed through the same first opening 204. The mating ends 312 of each pair of signal conductive elements 362 may be spaced center-to-center from each other by a pitch S1 in the row direction RD, and the intermediate portions 316 of each pair of signal conductive elements 362 may be spaced center-to-center from each other by a pitch S2 in the row direction RD. The pitch S1 may be greater than the pitch S2. With such a configuration, impedance consistency along the signal transmission path can be improved, thereby reducing crosstalk and improving signal integrity. In addition, two adjacent groups of conductive elements may be spaced apart from each other in the row direction RD by a pitch greater than the pitch S1.

In some embodiments, as illustrated in FIG. 3, for each pair of signal conductive elements 362 configured for carrying differential signals, the transition portions 318 may be bent along the row direction RD, such that the center line CL1 of the mating end 312 is offset from the center line CL2 of the intermediate portion 316 in the mating direction MD. The transition portion 318 of each signal conductive element 362 of each pair of signal conductive elements 362 is bent in the row direction RD away from the transition portion 318 of the other signal conductive element 362. Such a configuration enables the signal conductive elements 362 of each pair to be jogged away from each other at the mating ends to improve impedance consistency along the signal transmission path, thereby reducing crosstalk and improving signal integrity.

Each of the plurality of shell mating ends 334 of the shielding shell 122 is disposed between corresponding adjacent two groups of conductive elements 362 of the plurality of conductive elements 362 and adjacent to the mating ends 312 thereof. As shown in FIG. 2D, each shell mating end 334 and the mating end 312 of the adjacent conductive element 362 may be spaced center-to-center apart from each other in the row direction RD by a pitch S3. In some embodiments, the pitch S3 may be equal to the pitch S1. Such a design enables control of the pitches S1 and S3 in accordance with applicable industry standards.

The plurality of shell mating ends 334 of the shielding shell 122 may be integrally formed with the second shell part 304. The second shell part 304 may include a plate-shaped body 304a extending parallel to the row direction RD and the mating direction MD. The plurality of first openings 204 are provided in the plate-shaped body 304a. The plate-shaped body 304a may also include a plurality of first portions 332 and a second portion 333. Each first portion 332 is disposed between corresponding two adjacent first openings 204 of the plurality of first openings 204 in the row direction RD. Each first portion 332 is in the form of a contact bar to form a shell mating end 334 of the shielding shell 122. The shell mating end 334 has a mating contact surface 342. The mating contact surfaces 342 of the plurality of shell mating ends 334 may be coplanar with the outer surface of the second shell part 304. In addition, the mating contact surfaces 322 of the mating ends 312 of the plurality of conductive elements 362 may be disposed to be coplanar with the mating contact surfaces 342 of the plurality of shell mating ends 334. The mating contact surfaces 322 of the mating ends 312 of the plurality of conductive elements 362 may be disposed to be coplanar with the outer surface of the shielding shell 122. It should be appreciated that the present application may not be limited thereto, and that the mating contact surfaces 342 of the plurality of shell mating ends 334 and the mating contact surfaces 322 of the mating ends 312 of the plurality of conductive elements 362 may also be coplanar in a plane different from the plane in which the outer surface of the shielding shell 122 is located. The second portion 333 may extend above the intermediate portions 316 of the plurality of conductive elements 362 and join the plurality of first portions 332.

In the illustrated example, the plate-shaped body 304a may also include a front piece 336 that is disposed beyond the mating ends 312 of the plurality of conductive elements 362 in the mating direction MD. The front piece 336 may join the plurality of first portions 332, and the front piece 336 may extend in the vertical direction VD perpendicular to the row direction RD and the mating direction MD, e.g., extend perpendicularly to the broadsides 328 of the conductive elements 362.

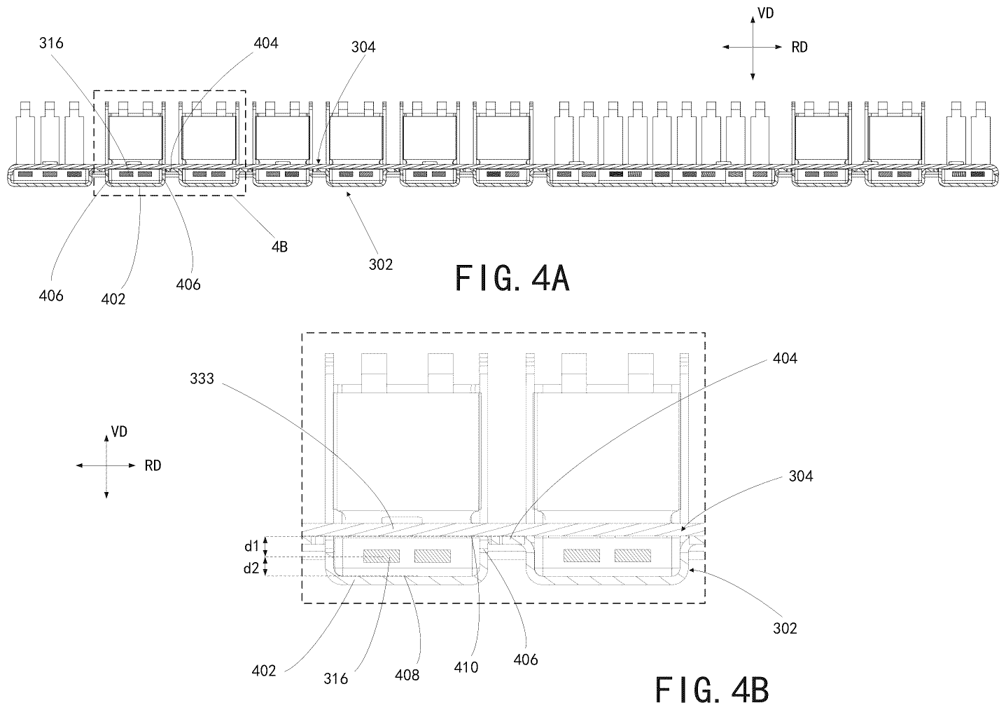

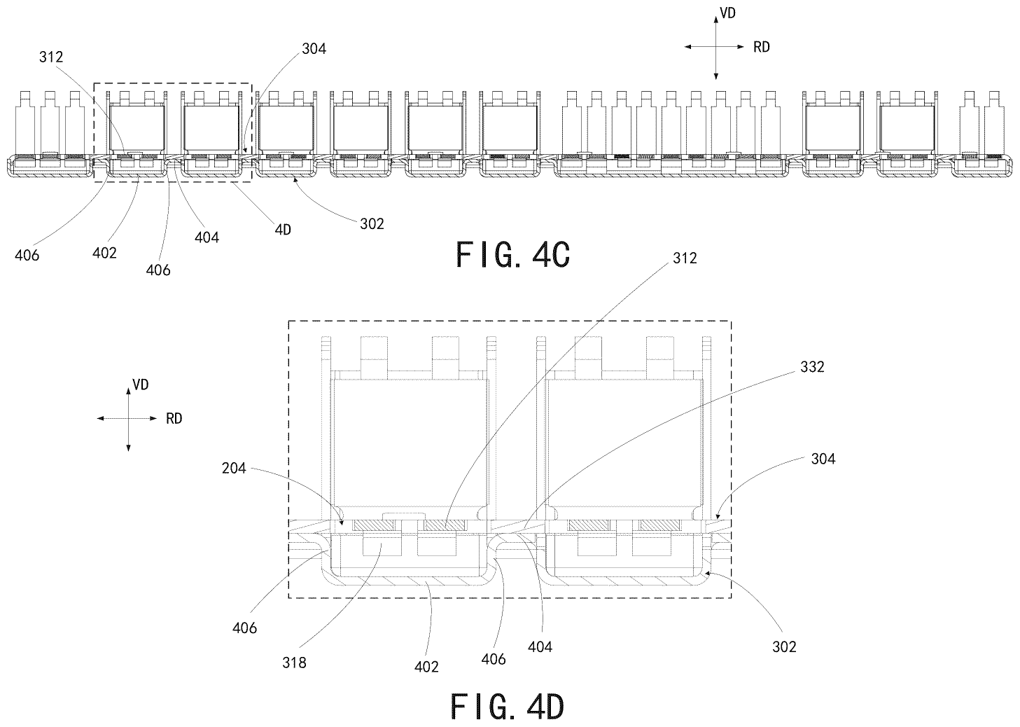

A desired shielding profile for each group of conductive elements 362 may be provided by disposing the intermediate portions 316 of the conductive elements 362 in each group in the center of the hollow interiors of the respective tubular structures 366. As illustrated in FIG. 4B, the first shell part 302 extends from the first surface 408 of the plateau 402 to the second surface 410 of the valley 404. The center lines CL2 of the intermediate portions 316 of the corresponding group of conductive elements 362 received in the tubular structure 366 are spaced apart from the first surface 408 by a distance d1 in the vertical direction VD perpendicular to the row direction RD and the mating direction MD, and is spaced apart from the second surface 410 by a distance d2 in the vertical direction VD. The distance d1 and the distance d2 may be configured to be equal. Each side 406 may extend perpendicularly to the center line CL2 along at least 50% of its length.

As shown in FIG. 4D, the shell mating ends (e.g., contact bars) 334 of the second shell part 304 may be attached to the valleys 404 of the first shell part 302 such that the mating ends 312 of the conductive elements 362 may be exposed through the first openings 204 between the shell mating ends 334. With the transition portions 318, the mating contact surfaces 322 of the conductive elements 362 may be disposed in the same plane as the mating contact surfaces 342 of the shell mating ends 334 of the second shell part 304.

The multi-dimensional shielding provided by the shielding shell 122 may extend to the tails 314 of the conductive elements in one or more groups, which may be configured for very high-speed signals. In the illustrated example, such shielding is extended to the tails 314 of the conductive elements 362 in the group 364B. In some embodiments, the first shell part 302 may include a plurality of first flaps 357. Each of the first flaps 357 extends from a corresponding side 406 of the first shell part 302 to a position between corresponding two adjacent groups of conductive elements 362 at the second opening 206 of the tubular structure 366, such that the corresponding two adjacent groups of conductive elements 362 are separated by two first flaps 357 in the row direction RD. The first shell part 302 may provide two sides of the multi-dimensional shielding at the tails by the first flaps 357.

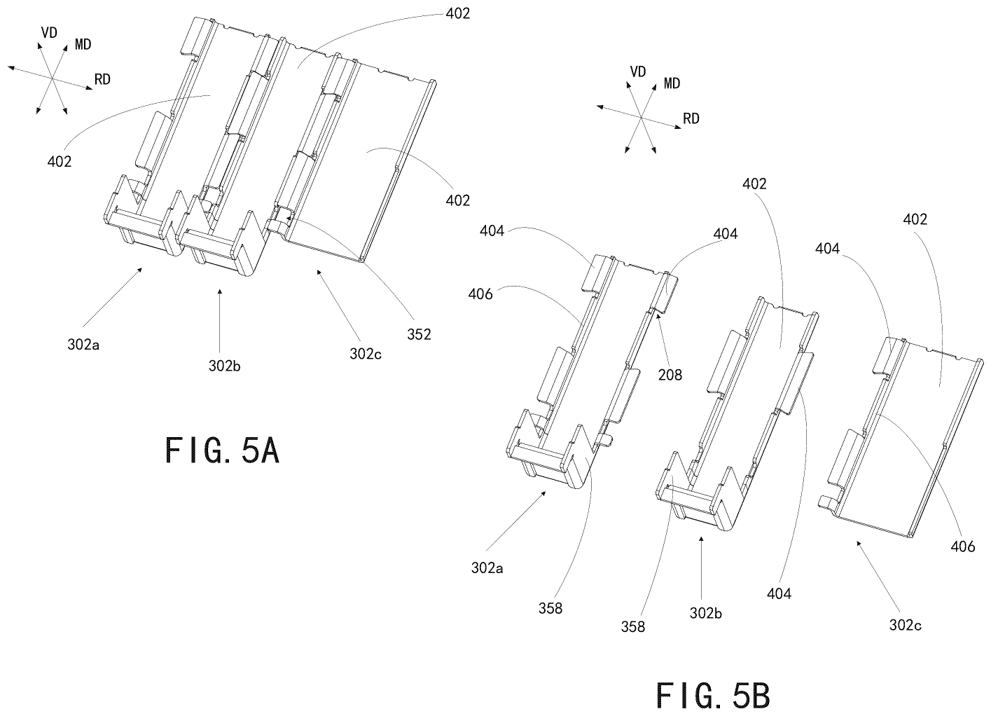

In some embodiments, the two first flaps 357 separating the corresponding two adjacent groups of conductive elements 362 in the row direction RD may be configured to be connected to the same conductive pad or conductive through hole of a circuit board. The two first flaps 357 may constitute a shell tail of the shielding shell 122. For example, the two first flaps 357 may be configured to be attached to the same conductive pad of the circuit board by welding. The tail 314 of each conductive clement 362 may include a first mounting contact surface 314a, and each first flap 357 may include a second mounting contact surface 357a. The first mounting contact surface 314a and the second mounting contact surface 357a may be coplanar. The first mounting contact surface 314a and the second mounting contact surface 357a may be perpendicular to the mating contact surface 322. In some embodiments, the two first flaps 357 may be configured to be inserted into the same conductive through hole of the circuit board. With such a configuration, reliable shielding may be provided along the signal transmission path of the conductive elements 362, thereby improving signal integrity. In some embodiments, as illustrated in FIG. 5A, the two first flaps 357 may be spaced apart from each other in the row direction RD, but may still be configured to be connected to the same conductive pad or conductive through hole of the circuit board. In some embodiments, the two first flaps 357 are engaged with each other to form a single mounting portion.

As illustrated in FIG. 2D, for each group of the plurality of groups of conductive elements 362, the tails 314 of two adjacent conductive elements 362 are spaced center-to-center apart from each other by a pitch S4 in the row direction RD. The two first flaps 357 separating the corresponding two adjacent groups of conductive elements 362 in the row direction RD are, as a whole, spaced center-to-center apart from the tail 314 of an adjacent conductive element 362 by a pitch S5 in the row direction RD. The pitch S4 and the pitch S5 may be configured to be equal. For example, In some embodiments, the pitch S4 may be 0.80 mm.

The conductive pads or conductive through holes on the circuit board may be positioned according to predefined standard. For example, the pads or through holes in a row, such as those for mounting high-speed conductive elements and their associated ground conductors, may have uniform pitches. Disposing the first flaps 357 between adjacent groups of conductive elements enables the techniques as described herein to be mounted on a PCB manufactured according to such standard for which pads or through holes for high-speed signal pairs are separated by a single ground pad or through hole. The tubular structures 366 around the groups provided by the shielding shell 122 may be grounded on both sides of the respective groups, which enables the plug connector 100 to carry high-speed signals.

In some embodiments, the first shell part 302 may include a plurality of second flaps 358. Each second flap 358 extends from a corresponding plateau 402 and joins two first flaps 357 corresponding to the same tubular structure 366. The first shell part 302 may provide three sides of the multi-dimensional shielding at the tails by the first flaps 357 and the second flaps 358. Forming the flaps 357 and 358 as part of the same piece as the sides 406 and the plateaus 402 may enable substantially shielding the conductive elements 362 over substantially all of their length. The second shell part 304 may include a plurality of rear pieces 359. The rear pieces 359 may extend from the second portion 333 of the plate-shaped body 304a oppositely to the first portion 332. Each rear piece 359 may form an annular portion with two first flaps 357 and one second flap 358 corresponding to the same tubular structure 366 to surround the tails 314 of a corresponding group of conductive elements 362. The second shell part 304 may provide shielding on a fourth side at the tails by the rear pieces 359. In this way, shielding may be provided on all four sides at the tails.

The flaps 357 may be aligned with corresponding sides 406 in the mating direction, or may be offset from the corresponding sides 406 in the mating direction. The flaps 358 may be aligned with corresponding plateaus 402 in the mating direction MD, or may be offset from the corresponding plateaus 402 in the mating direction MD.

In some embodiments, the first shell part 302 may include a plurality of subparts (the subparts 302a, 302b, and 302c shown in FIGS. 5A and 5B). Each of the plurality of subparts includes at least one plateau 402, at least two sides 406, and at least a portion of at least one valley 404, with the plurality of subparts connected to each other at the valley 404. For example, the multiple subparts may be combined into one structure through, for example, matching features 208. In this case, two adjacent first flaps 358 of two adjacent subparts may be configured to be connected to the same conductive pad or conductive through hole of a circuit board. In some embodiments, the first shell part 302 may be a single monolithic member.

The present application also proposes a method for forming the connector subassembly 200 and the plug connector 100. The second shell part 304 of the shielding shell 122 may be formed by stamping a metal sheet into a one-piece blank. The one-piece blank may be formed, such as by folding, into the shape illustrated in FIGS. 2E and 2F. The first shell part 302 may be formed by stamping a metal sheet into a one-piece blank, which may be folded into the shape illustrated in FIGS. 2E and 2F; or the first shell part 302 may be formed by stamping one or more metal sheets into multiple subparts (e.g., subparts 302a, 302b, and 302c shown in FIGS. 5A and 5B), each of which may be folded to have at least one plateau 402, at least two sides 406, and at least a portion of at least one valley 404. The multiple subparts may be then combined into one structure through, for example, matching features 208. As shown in FIGS. 2F and 5A, the valleys 404 of the first shell part 302 may have openings 352 extending therethrough and aligned in a line. The lead assembly 306 may be inserted into the first shell part 302 by aligning and placing the connecting portions 310 of the insulative member 320 to the line of the openings 352. The second shell part 304 may be then attached (e.g., by welding) to the first shell part 302 to form the connector subassembly 200. The connector subassembly 200 may be then disposed into the channel 110 of the housing 102 of the plug connector 100.

Techniques described herein may also be embodied as receptacle connectors. For example, the receptacle connector 500 is shown here in a configuration in which it may mate with the plug connector 100. In the illustrated example, the receptacle connector 500 may be a receptacle connector compliant with the SSF-8639 standard, to be combined with the mating plug connector 100 to constitute the electrical connector assembly described above. Accordingly, the mating ends of the conductive elements of the plug connector 100 are blade-shaped, while the mating ends of the conductive elements of the receptacle connectors 500 have a complementary configuration, here illustrated as beams that deflect upon mating to generate a contact force.

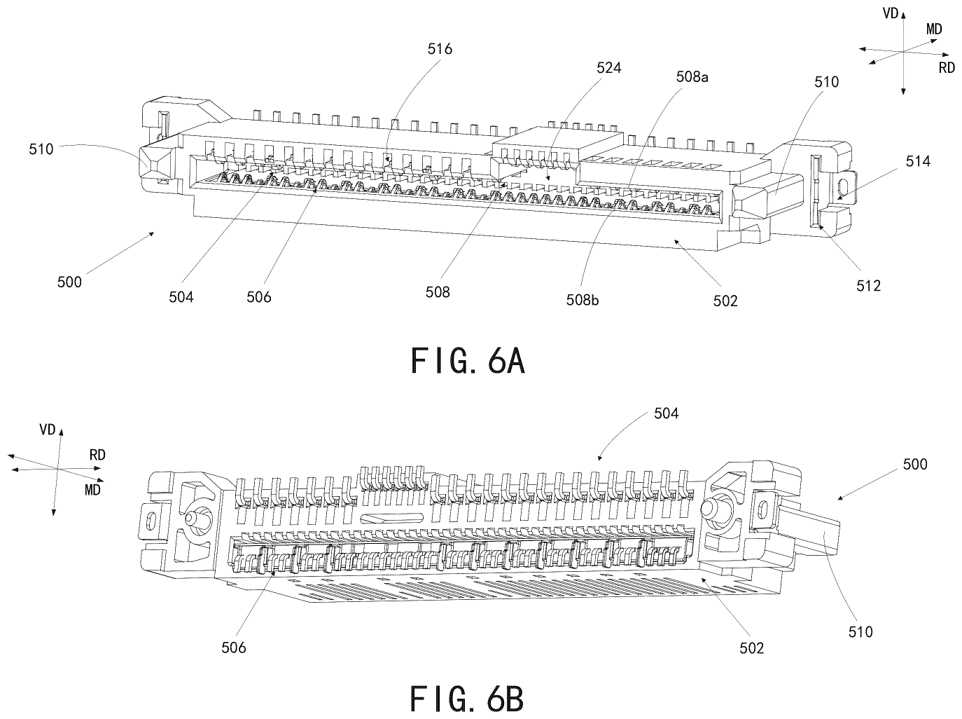

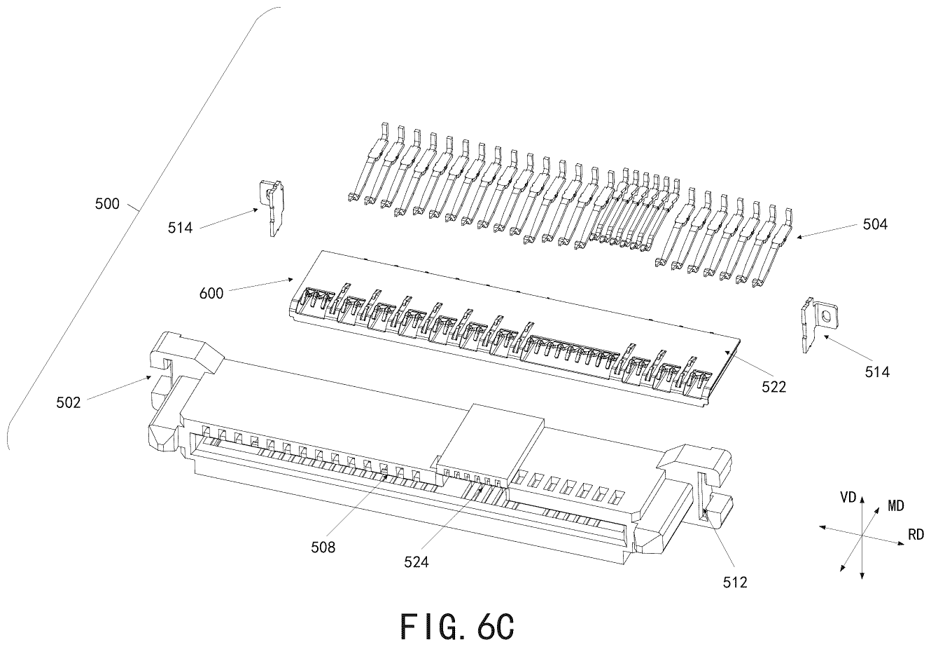

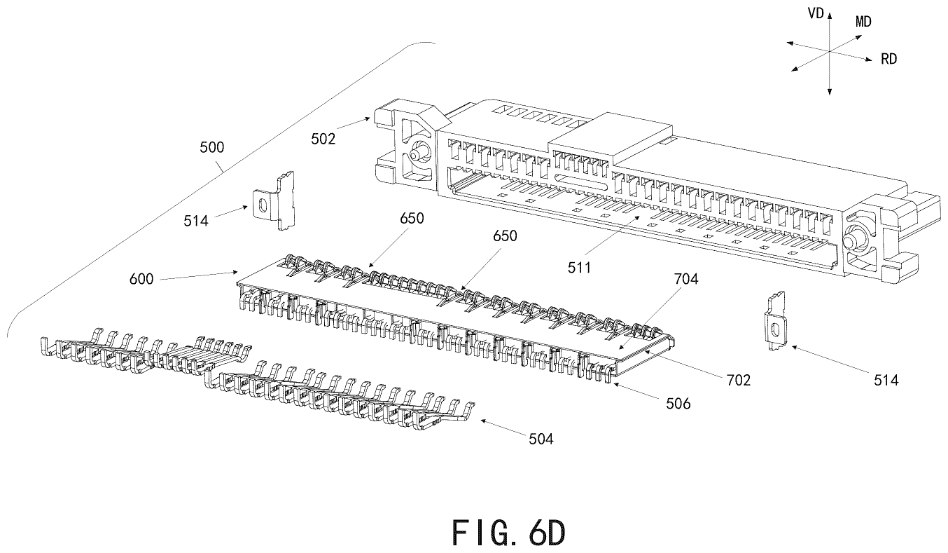

As shown in FIGS. 6A to 6D, the receptacle connector 500 may include an insulative housing 502, which may have a slot 508 elongated in a row direction RD. The housing 502 may also include guide members 510 that may extend at opposite ends of the slot 508. The guide members 510 may be configured to engage complementary guide members of another electrical component (e.g., the openings 121 of the guide members 116 of the plug connector 100). The housing 502 may also include slots 512 on opposite ends, with locking members 514 inserted in the slots 512. The locking members 514 may be configured to enhance the attachment between the receptacle connector 500 and another electrical component to which the receptacle connector 500 that is mounted, such as a circuit board (e.g., a backplane, a midplane, a driver carrier board). The housing 502 may include channels 516 shaped and disposed to receive respective conductive elements.

The connector 500 may include a top row 504 of conductive elements and a bottom row 506 of conductive elements, separated from each other by the slot 508 of the housing 502. The slot 508 may include a first side 508a and a second side 508b opposed to each other. As shown, the top row 504 of conductive elements may include conductive elements that may be shaped differently for various purposes including, for example, signal, ground, power, or any suitable purposes. The top row 504 may be disposed along the first side 508a of the slot 508, which may have a recess 524 to distinguish from the second side 508b of the slot 508 that may hold the bottom row 506. The bottom row 506 of the conductive element may also include conductive elements that may be shaped differently for various purposes including, for example, signal, ground, power, or any suitable purposes. The bottom row 506 contains groups of signal conductors configured for high-speed signals.

The connector 500 may include, in one or more rows, connector subassemblies configured to reduce crosstalk and enable high-speed transmissions. In the illustrated example, the bottom row 506 of conductive elements and the associated shielding shell 522 form a connector subassembly 600. Each connector subassembly 600 may include one or more features for engaging with the connector housing 502 such that each subassembly 600 may be inserted into and then retained in the housing 502. In the illustrated example, each subassembly 600 may be retained within the housing 502 by being sized and shaped to fit in the channel 511. The channel 511 may be located at the second side 508b of the slot 508, as shown in FIG. 6D.

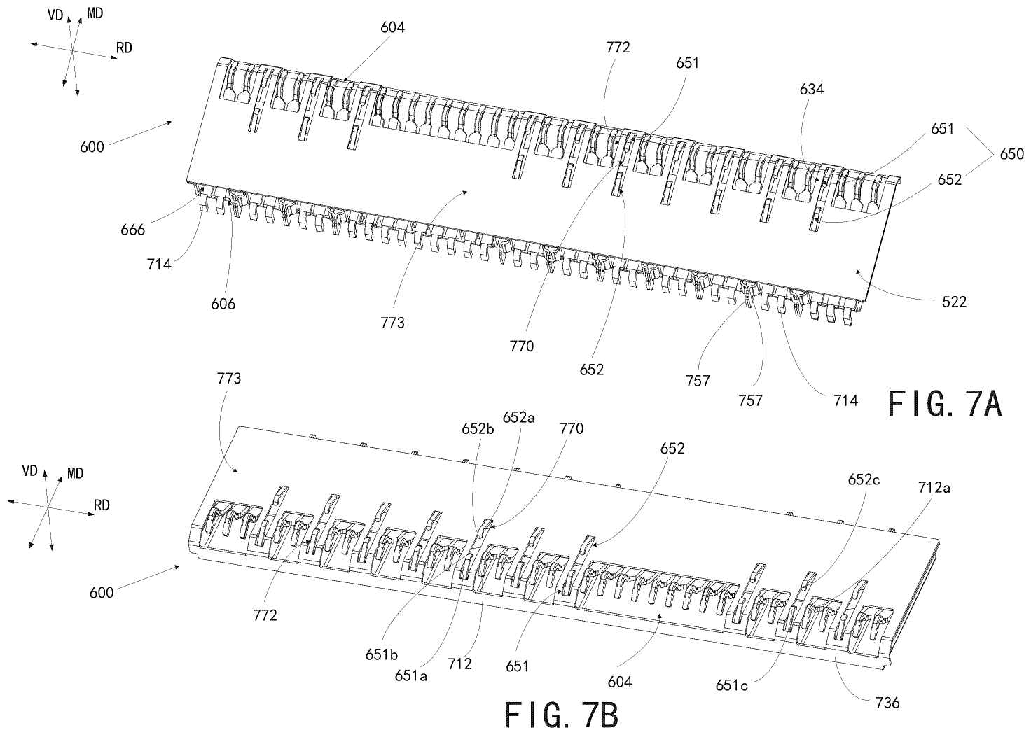

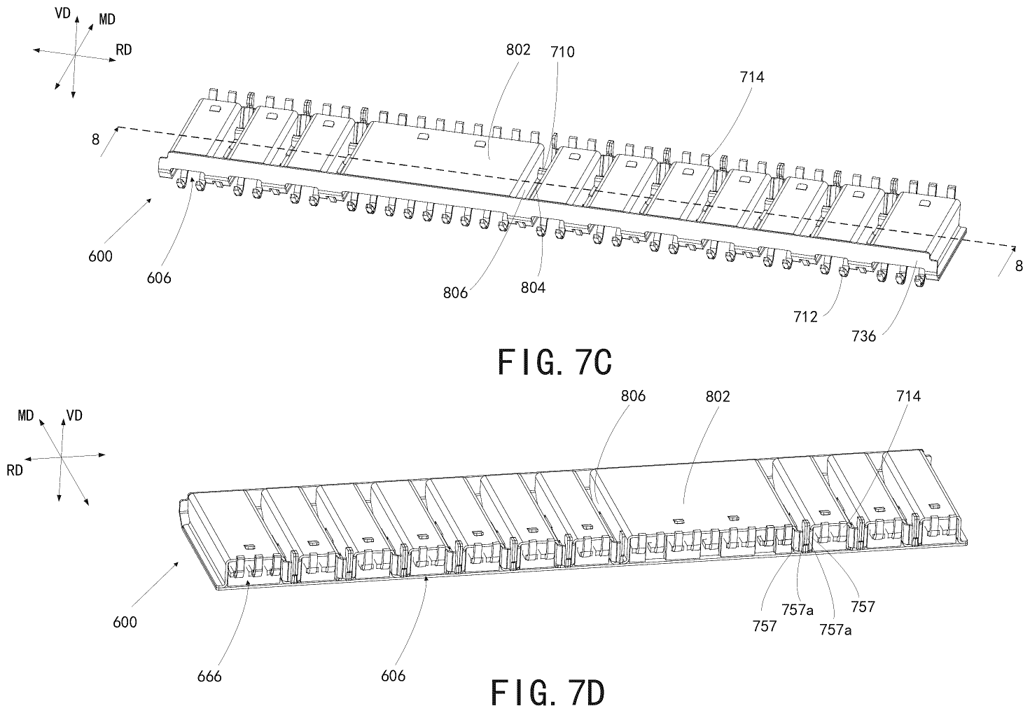

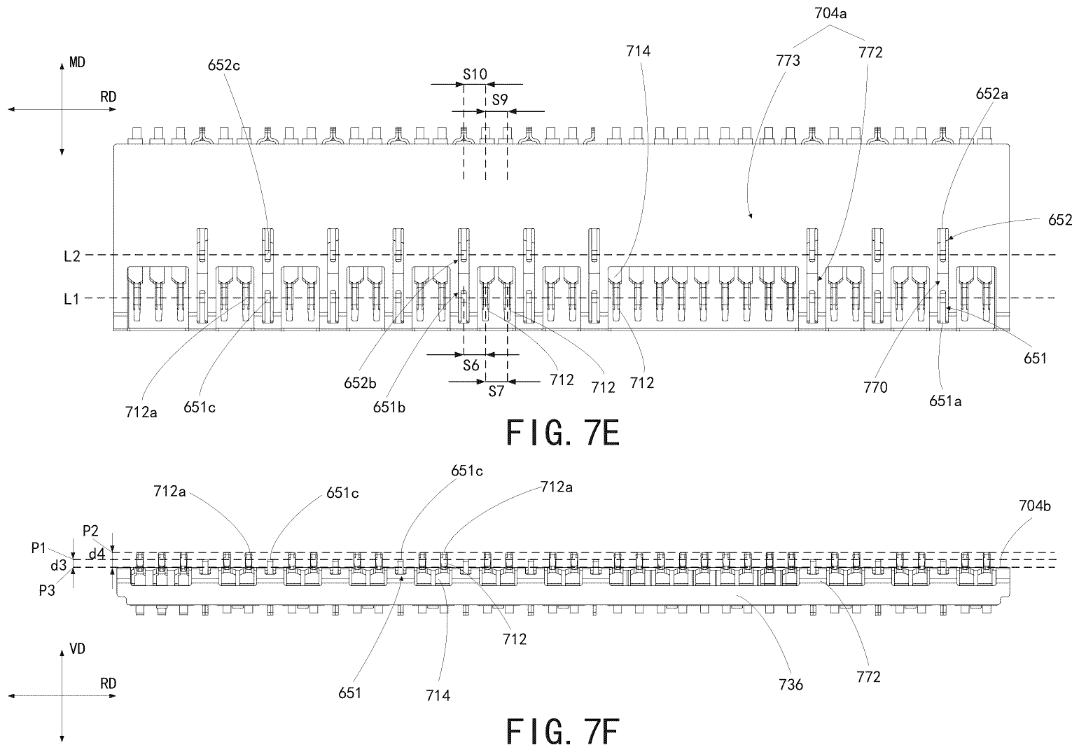

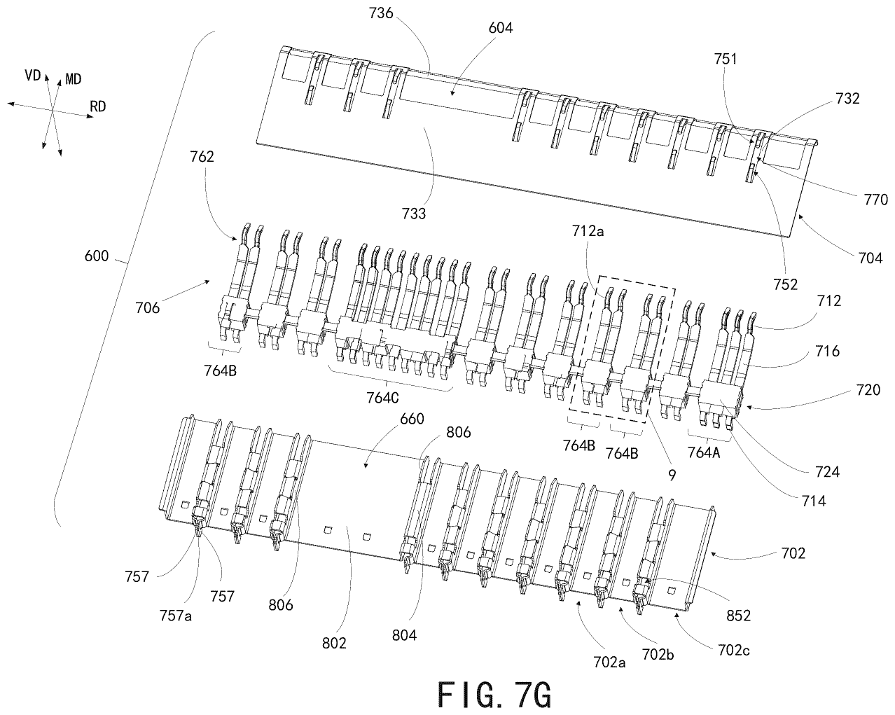

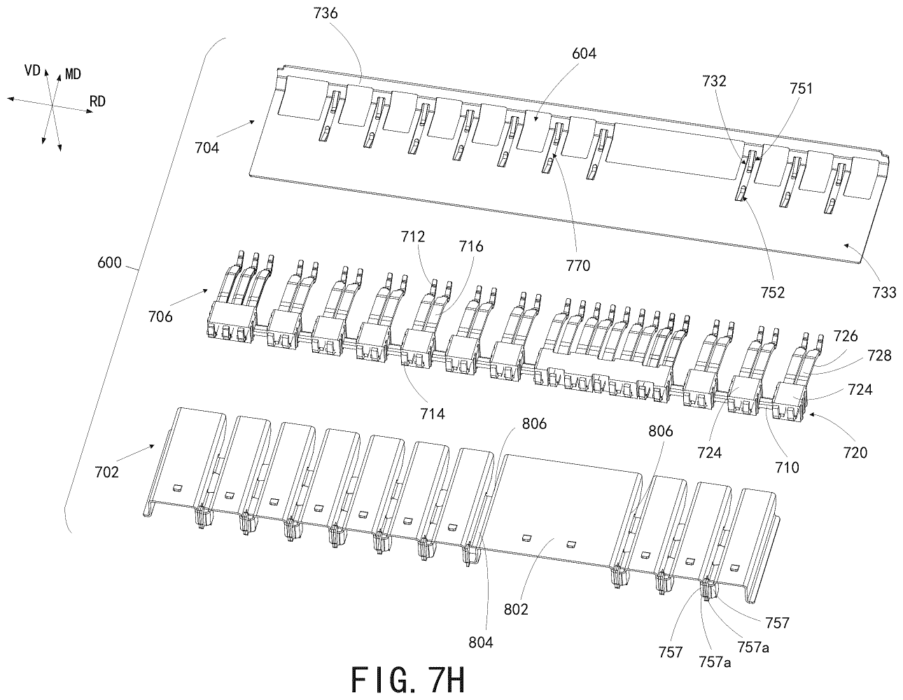

Similar to the connector subassembly 200 of the plug connector 100, the connector subassembly 600 of the receptacle connector 500 may include a shielding shell 522 and a lead assembly 706, as shown in FIGS. 7A to 10B. The lead assembly 706 may include a plurality of conductive elements 762. The conductive elements 762 may be configured as signal conductors. Each conductive element 762 includes a mating end 712, a tail 714 opposite to the mating end 712, and an intermediate portion 716 joining the mating end 712 and the tail 714. The intermediate portion 716 may extend between the mating end 712 and the tail 714.

Different from the mating ends 312 of the conductive elements 362 of the plug connector 100, the mating end 712 of each conductive element 762 of the receptacle connector 500 has a convexly curved shape to protrude out of the shielding shell 522, as illustrated in FIGS. 7G, 7H, and 9. In some embodiments, for each conductive element 762, the mating end 712 is curved to have a convexly curved shape with a contact apex portion 712a. At least the contact apex portion 712a of the mating end 712 is located outside of the shielding shell 522. Each conductive element 762 includes edges 726 and broadsides 728 joined by the edges 726. The contact apex portion 712a of the mating end 712 may define a mating contact surface of the mating end 712. For each conductive element 762, the intermediate portion 716 extends from the mating end 712 in the mating direction MD.

The lead assembly 706 may also include an insulative member 720 for holding the plurality of conductive elements 762. The insulative member 720 may hold at least the intermediate portions 716 of the plurality of conductive elements 762, such that the plurality of conductive elements 762 are arranged in a row. The row extends along a row direction RD. In the row, the plurality of conductive elements 762 may be arranged in an edge-to-edge manner, and the plurality of conductive elements 762 may be disposed as a plurality of groups of conductive elements 762 spaced apart from each other along the row direction RD. The row direction RD is perpendicular to the mating direction MD. The mating end 712 of each conductive element 762 is oriented in the mating direction MD.

The conductive elements 762 may be disposed in groups based on terminal assignments of a desired standard. In the illustrated example, the conductive elements 762 are disposed into three different kinds of groups 764A, 764B, and 764C. Each kind of groups may include different numbers of conductive elements 762. The insulative member 720 may include a holding portion 724 that holds the conductive elements 762 in one group in an edge-to-edge configuration. The insulative member 720 may also include connecting portions 710 that connect the adjacent holding portions 724. The insulative member 720 may hold portions of the intermediate portions 716 of the conductive elements 762. The portions of the intermediate portions 716 held by the insulative member 720 may be along less than 50% of the lengths of the conductive elements 762, and in some embodiments, less than 40%, 30%, 20%, or 10% of the lengths of the conductive elements 762. This configuration may reduce impedance imbalance along the lengths of the conductive elements 762.

The shielding shell 522 may be configured with tubular structures 666 that each provides multi-dimensional shielding for one group of conductive elements 762, and shell mating ends (here shown as pairs of contact arms) 634 enabling the receptacle connector 500 to be compatible to physical requirements of corresponding industry standards. Such a configuration enables high-speed transmission, without the need to redesign mating electrical components such as the peripherals that may be designed and manufactured by different companies according to a standard that specifies locations of the mating and mounting contact surfaces. As shown, the shielding shell 522 may extend from the mating ends 712 to the tails 714 of the conductive elements 762. The shielding shell 522 may have a front piece 736 disposed beyond the mating ends 712 of the conductive elements 762. The shielding shell 522 may have a plurality of first openings 604 and a plurality of second openings 606. The shielding shell 522 may be disposed around the plurality of conductive elements 762 and insulative members 720, such that the intermediate portions 716 of the plurality of conductive elements 762 and the insulative members 720 are disposed within the shielding shell 122, and such that the mating ends 712 of each group of the plurality group of conductive elements 762 are exposed through a corresponding one of the plurality of first openings 604, and such that the tails 714 of each group of the plurality group of conductive clement 762 are exposed through a corresponding one of the plurality of second openings 606. In the illustrated example, the mating ends 712 of the conductive elements 762 are exposed through the openings 604 in the shielding shell 522 that open in a direction (e.g., the vertical direction VD) perpendicular to the elongated dimension of the conductive elements 762.

Similar to the shielding shell 122 of the plug connector 100, the shielding shell 522 of the receptacle connector 500 may include one or more shell parts. In the illustrated example, the shielding shell 522 includes a first shell part 702 and a second shell part 704 configured to be attached to the first shell part 702 to form the tubular structures 666 each substantially surrounding the conductive elements 762 in one group. In some embodiments, the first shell part 702 includes a plurality of plateaus 802, a plurality of valleys 804, and sides 806 joining adjacent plateaus 802 and valleys 804. Each plateau 802 and the corresponding two sides 806 may form a channel 660. Each channel 660 is configured to receive the intermediate portions 716 of a corresponding group of conductive elements 762. The plateau 802 extends at least from the distal ends of the mating ends 712 of the corresponding group of conductive elements 762 to the holding portion 724 of the insulative member 720. The second shell part 704 includes the plurality of first openings 604 as described above. The second shell part 704 is attached to the first shell part 702 at the plurality of the valleys 804 and is opposed to the plurality of plateaus 802 in a vertical direction VD perpendicular to the row direction RD and the mating direction MD to enclose the tubular structures 666 with each plateau 802 and the corresponding two sides 806. The second shell part 704 may close the one side left open by the channel 660 and provide shielding on this side. The intermediate portions 716 of a corresponding group of conductive elements 762 are received in the tubular structure 666. Each of the plurality of valleys 804 is disposed between corresponding two adjacent groups of the plurality of groups of conductive elements 762.

Each tubular structure 666 includes a first end and a second end opposite to each other. The first end of the tubular structure 666 is in communication with a corresponding one of the plurality of first openings 604 to allow the mating end 712 of a corresponding group of conductive elements 762 to be exposed through the corresponding first opening 604. The tubular structure 666 may define a second opening 606 at the second end, and the tails 714 of the corresponding group of conductive elements 762 are exposed through the second opening 606.

Different from the shielding shell 122 of the plug connector 100, the shielding shell 522 of the receptacle connector 500 may also include a plurality of pairs of contact arms, with each pair of contact arms forming a shell mating end 634. In the illustrated example, the second shell part 704 may include a plurality of pairs of contact arms 650. Each pair of the plurality of pairs of contact arms 650 may be disposed between corresponding two adjacent groups of the plurality groups of conductive elements 762 and adjacent to the mating ends 712 thereof. Each pair of contact arms 650 may include a first contact arm 651 and a second contact arm 652 spaced apart from each other in the mating direction MD. The first contact arm 651 and the second contact arm 652 may together form a shell mating end 634 of the shielding shell 522 for mating with a corresponding conductive structure of the mating plug connector 100. In the illustrated example, the first contact arm 651 and the second contact arm 652 are configured to contact with the same contact bar 334 of the shielding shell 122 of the plug connector 100 to establish a connection. With the first contact arm 651 and the second contact arm 652, a dual ground connection may be provided at the same shell mating end 634 to provide reliable shielding along the signal transmission path and to reduce crosstalk, thereby improving signal integrity.

For each pair of contact arms 650, the first contact arm 651 may include a first end 651a and a second end 651b opposite to each other, and the second contact arm 652 may include a first end 652a and a second end 652b opposite to each other. For the first contact arm 651, the first end 651a may be configured to be fixed, and the second end 651b may be configured to be unfixed. The first contact arm 651 may be a cantilever beam. For the second contact arm 652, the first end 652a may be configured to be fixed, and the second end 652b may be configured to be unfixed. The second contact arm 652 may be a cantilever beam. The first contact arm 651 and the second contact arm 652 may be arranged along the mating direction MD such that the second end 651b of the first contact arm 651 and the second end 652b of the second contact arm 652 are opposed to each other in the mating direction MD, and such that the first end 651a of the first contact arm 651 and the first end 651a of the second contact arm 652 are opposite to each other in the mating direction MD. The first contact arm 651 and the second contact arm 652 may be aligned with each other along the mating direction MD, such that the second end 651b of the first contact arm 651 and the second end 652b of the second contact arm 652 are close to each other in the mating direction MD, and such that the first end 651a of the first contact arm 651 and the first end 651a of the second contact arm 652 are far away from each other in the mating direction MD. With such a configuration, it facilitates establishing a reliable ground connection and reducing crosstalk.

In some embodiments, as shown in FIGS. 7A to 7F, for each pair of contact arms 650, the first contact arm 651 may be disposed between the mating ends 712 of corresponding two adjacent groups of conductive elements 762, and the second contact arm 652 may be disposed between portions of the intermediate portions 716 of the corresponding two adjacent groups of conductive elements 762 adjacent to the mating ends 712. It should be appreciated that the present application may not be limited thereto, and that In some embodiments, the second contact arm 652 may also be disposed between the mating ends 712 of the corresponding two adjacent groups of conductive elements 762.

As shown in FIG. 7E, for each pair of contact arms 650, the second end 651b of the first contact arm 651 and the mating end 712 of an adjacent conductive element 762 may be spaced apart center-to-center from each other by a pitch S6 in the row direction RD. As shown in FIGS. 7E and 9, for each group of the plurality of groups of conductive elements 762, the mating ends 712 of two adjacent conductive elements 762 may be spaced apart center-to-center from each other by a pitch S7 in the row direction RD. The pitch S6 and the pitch S7 may be configured to be equal. Such a design enables control of the pitches S6 and S7 in accordance with applicable industry standards.

In some embodiments, the second end 651b of the first contact arm 651 may have a convexly curved shape with a first contact apex portion 651c, as illustrated in FIG. 7B. The first contact apex portion 651c may define a mating contact surface of the first contact arm 651. As shown in FIG. 7E, the first contact apex portions 651c of the second ends 651b of the first contact arms 651 of the plurality of pairs of contact arms may be aligned along a first line L1 parallel to the row direction RD. Further, as shown in FIG. 7F, the first contact apex portions 651c of the second ends 651b of the first contact arms 651 of the plurality of pairs of contact arms may be coplanar in a first plane P1 parallel to the row direction RD and the mating direction MD. Similar to the first contact arm 651, the second end 652b of the second contact arm 652 may have a convexly curved shape with a second contact apex portion 652c, as illustrated in FIG. 7B. The second contact apex portion 652c may define a mating contact surface of the second contact arm 652. As shown in FIG. 7E, the second contact apex portions 652c of the second ends 652b of the second contact arms 652 of the plurality of pairs of contact arms 652 may be aligned in a second line L2 parallel to the row direction RD. The second line L2 and the first line LI may be spaced apart from each other in the mating direction MD. Furthermore, as shown in FIG. 7F, the second contact apex portions 652c of the second ends 652b of the second contact arms 652 of the plurality of pairs of contact arms may be coplanar in the first plane P1. The first contact apex portions 651c of the first contact arms 651 may be coplanar with the second contact apex portions 652c of the second contact arms 652. It should be appreciated that the present application may not be limited thereto. In some embodiments, the first contact apex portions 651c of the first contact arms 651 may not be coplanar with the second contact apex portions 652c of the second contact arms 652.

As described above, for each conductive element 762, the mating end 712 may be curved to have a convexly curved shape with the contact apex portion 712a. The contact apex portion 712a may define the mating contact surface of the mating end 712. As shown in FIG. 7E, the contact apex portions 712a of the mating ends 712 of the plurality of conductive elements 762 may be aligned in the first line L1. The first contact apex portions 651c of the second ends 651b of the first contact arms 651 of the plurality of pairs of contact arms and the contact apex portions 712a of the mating ends 712 of the plurality of conductive elements 762 may be aligned in the row direction RD. It should be appreciated that the present application may not be limited thereto. In some embodiments, the first contact apex portions 651c of the second ends 651b of the first contact arms 651 of the plurality of pairs of contact arms and the contact apex portions 712a of the mating ends 712 of the plurality of conductive elements 762 may be offset from each other in the row direction RD.

As shown in FIG. 7F, the contact apex portions 712a of the mating ends 712 of the plurality of conductive elements 762 may be coplanar in a second plane P2 parallel to the row direction RD and the mating direction MD. The second plane P2 may be the same as or different from the first plane P1.

The plurality of pairs of contact arms 650 of the shielding shell 733 may be integrally formed with the second shell part 704. The second shell part 704 may include a plate-shaped body 704a extending parallelly to the row direction RD and the mating direction MD. The plurality of first openings 604 are provided in the plate-shaped body 704a. The first ends 651a of the first contact arms 651 and the first ends 652a of the second contact arms 652 of the plurality of pairs of contact arms are connected to the plate-shaped body 704a, and the second ends 651b of the first contact arms 651 and the second ends 652b of the second contact arms 652 of the plurality of pairs of contact arms protrude above an outer surface 704b of the plate-shaped body 704a. As shown in FIG. 7F, the first plane P1 may be at a distance d3 (as schematically indicated by the dashed line P3 in FIG. 7F) from the outer surface 704b of the plate-shaped body 704a in the vertical direction VD perpendicular to the row direction RD and the mating direction MD. The contact apex portions 712a of the mating ends 712 of the plurality of conductive elements 762 may protrude above the outer surface of the plate-shaped body 704a through the corresponding first openings 204, such that the second plane P2 is at a distance d4 (as schematically indicated by the dashed line P3 in FIG. 7F) from the outer surface 704b of the plate-shaped body 704a in the vertical direction VD. The distance d3 may be greater than the distance d4. Such a configuration can facilitate formation of reliable signal and ground connections between the receptacle connector 500 and a mating plug connector (e.g., the plug connector 100). In some embodiments, the distance d3 may be equal to the distance d4. In this case, the second plane P2 is the same as the first plane P1.

The plate-shaped body 704a may also include a plurality of first portions 772 and a second portion 773. Each first portion 772 may be disposed between corresponding two adjacent first openings 604 of the plurality of first openings 604 in the row direction RD. The second portion 773 may extend above the intermediate portions 716 of the plurality of conductive elements 762 and join the plurality of first portions 772. For each pair of the plurality of pairs of contact arms, the first contact arm 651 is a resilient arm cut out (e.g., by stamping) from a corresponding first portion 772. Alternatively or additionally, the second contact arm 652 is a resilient arm cut out (e.g., by stamping) from the second portion 773. The first contact arms 651 and the second contact arms 652 each extend in the manner of a cantilever beam.

As shown in FIGS. 7G and 7H, for each pair of contact arms 650, the first end 651a of the first contact arm 651 and the first end 652a of the second contact arm 652 are connected to the plate-shaped body 704a. The plate-shaped body 704a may include a continuous slot 770 extending between the first end 651a of the first contact arm 651 and the first end 652a of the second contact arm 652. The slot 770 may be formed, for example, when the first contact arm 651 and the second contact arm 652 are cut out from the plate-shaped body 704a. A portion of the slot 770 between the corresponding two adjacent first openings 204 extends in a corresponding first portion 772 of the plate-shaped body 704a without being in communication with the corresponding two adjacent first openings 204. The corresponding two adjacent first openings 204 may be spaced apart by portions of the first portion 772 and the slot 770 in the row direction RD. With such a configuration, crosstalk can be further reduced, thereby improving signal integrity. In some other embodiments, the slot 770 may not be continuous in the mating direction MD, but rather interrupted by a portion of a corresponding first portion 772.

Furthermore, the front piece 736 of the shielding shell 733 may join the plurality of first portions 772. With the front piece 736, a shorter electrically conductive path can be provided between the respective first contact arms 651. In addition, with the second portion 773, a shorter electrically conductive path can be provided between the respective second contact arms 652. Such a configuration facilitates reducing crosstalk. The front piece 736 may extend in the vertical direction VD perpendicular to the row direction RD and the mating direction MD.

The plurality of groups of conductive elements 762 may include a plurality of pairs of signal conductive elements 762 (e.g., the group 764B) configured for carrying differential signals. FIG. 9 illustrates two pairs of signal conductive elements 762 for carrying differential signals. The signal conductive elements 762 in each pair of signal conductive elements 762 are adjacent to each other in the row direction RD with the mating ends 712 thereof exposed through the same first opening 604. As shown in FIG. 9, for each pair of signal conductive elements, the mating ends 712 may each have a first width W1 in the row direction RD and the intermediate portions 716 may each have a second width W2 in the row direction RD. The first width W1 may be less than the second width W2. As described above, the mating ends 712 of each pair of signal conductive elements may be spaced apart center-to-center from each other by the pitch S7 in the row direction RD. In addition, the intermediate portions 716 of each pair of signal conductive elements may be spaced apart center-to-center from each other by a pitch S8 in the row direction RD. The pitch S7 may be greater than the pitch S8. With such a configuration, impedance consistency along the signal transmission path can be improved, thereby reducing crosstalk and improving signal integrity.

In some embodiments, as illustrated in FIG. 9, the center line CL3 of the mating end 712 of each signal conductive element 762 in each pair of signal conductive elements 762 may be offset from the center line CL4 of the intermediate portion 716 thereof and away from the other signal conductive element 762 in the row direction RD. Such a configuration enables the signal conductive elements 762 of each pair of signal conductive elements to be jogged away from each other at the mating ends to improve impedance consistency along the signal transmission path, thereby reducing crosstalk and improving signal integrity.

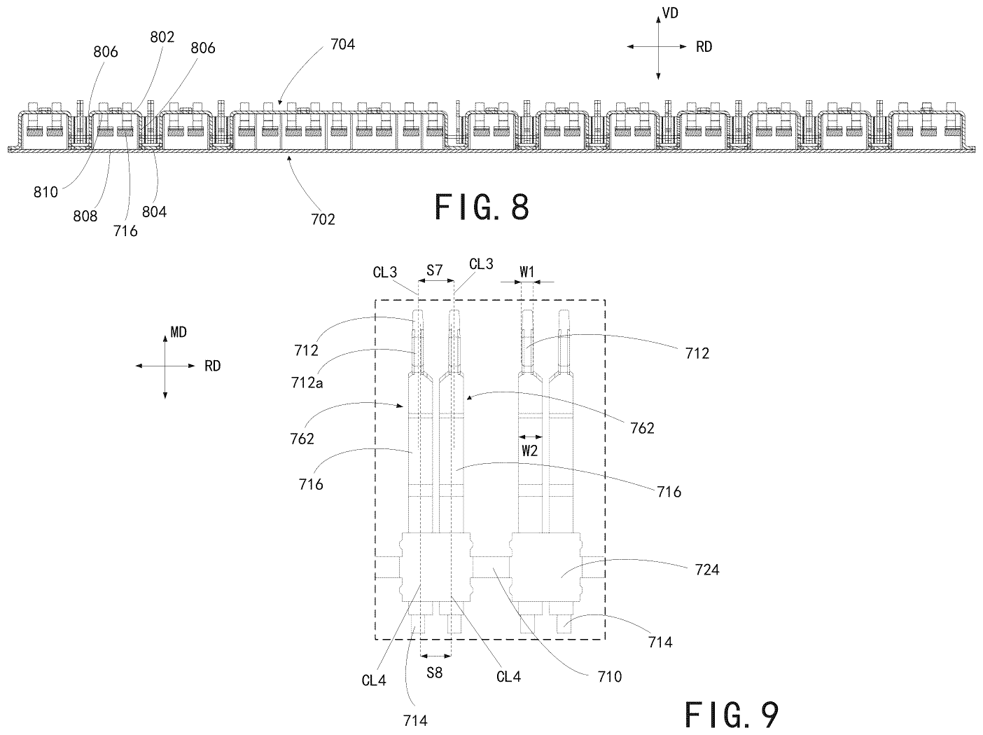

A desired shielding profile for each group of conductive elements 762 may be provided by disposing the intermediate portions 716 of the conductive elements 762 in each group in the center of the hollow interiors of the respective tubular structures 666. As illustrated in FIG. 8, the first shell part 702 extends from the first surface 808 of the plateau 802 to the second surface 810 of the valley 804. Similar to the plug connector 100, for the receptacle connector 500, a distance by which the intermediate portions 716 of the conductive elements 762 of a corresponding group of conductive elements 762 received in the tubular structure 666 are spaced apart from the first surface 808 in the vertical direction VD may be equal to a distance by which the intermediate portions 716 are spaced apart from the second surface 810 in the vertical direction VD. Each side 806 may extend perpendicularly to the center line CL2 along at least 50% of its length.

The first portions 772 of the second shell part 704 may be attached to the valleys 804 of the first shell part 702, such that the mating ends 712 of the conductive elements 762 may be exposed through the first openings 604 between the first portions 772.

The multi-dimensional shielding provided by the shielding shell 733 may extend to the tails 714 of the conductive elements in one or more groups, which may be configured for very high-speed signals. In the illustrated example, such shielding is extended to the tails 714 of the conductive elements 762 in the group 764B. In some embodiments, the first shell part 702 may include a plurality of first flaps 757. Each of the first flaps 757 may extend from a corresponding side 806 of the first shell part 702 to a position between the corresponding two adjacent groups of conductive elements 762 at the second opening 606 of the tubular structure 666, such that the corresponding two adjacent groups of conductive elements 762 are separated by two first flaps 757 in the row direction RD. The first shell part 702 may provide two sides of the multi-dimensional shielding at the tail by the first flaps 757.

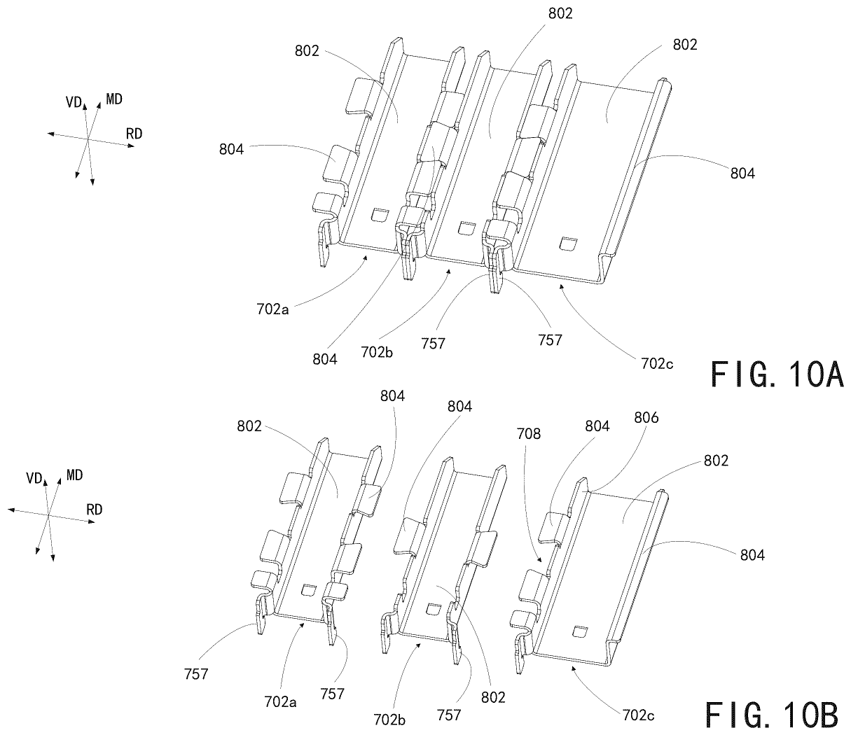

In some embodiments, the two first flaps 757 separating the corresponding two adjacent groups of conductive elements 762 in the row direction RD may be configured to be connected to the same conductive pad or conductive through hole of a circuit board. The two first flaps 757 may constitute a shell tail of the shielding shell 522. In this manner, a reliable connection may be provided. For example, the two first flaps 757 may be configured to be connected to the same conductive pad of the circuit board by welding. The tail 614 of each conductive element 662 may include a first mounting contact surface 614a, and each first flap 757 may include a second mounting contact surface 757a. The first mounting contact surface 614a and the second mounting contact surface 757a may be coplanar. The first mounting contact surface 614a and the second mounting contact surface 757a may be perpendicular to the mating contact surface. In some embodiments, the two first flaps 757 may be configured to be inserted into the same conductive through hole of the circuit board. With such a configuration, reliable shielding may be provided along the signal transmission path of the conductive elements 762, thereby improving signal integrity. In some embodiments, as illustrated in FIG. 10A, the two first flaps 757 may be engaged with each other to form a single mounting portion. In some embodiments, the two first flaps 757 may be spaced apart from each other in the row direction RD, but may still be connected to the same conductive pad or conductive through hole of the circuit board.

As illustrated in FIG. 7E, for each group of the plurality of group of conductive elements 762, the tails 714 of two adjacent conductive elements 762 may be spaced apart center-to-center from each other by a pitch S9 in the row direction RD. The two first flaps 357 separating the corresponding two adjacent groups of conductive elements 762 in the row direction RD may be, as a whole, spaced center-to-center apart from the tail 714 of an adjacent conductive element 762 by a pitch S10 in the row direction RD. The pitch S9 and the pitch S10 may be configured to be equal. For example, In some embodiments, the pitch S9 may be 0.80 mm.

The conductive pads or conductive through holes on the circuit board may be positioned according to predefined standard. For example, the pads or through holes in a row, such as those for mounting high-speed conductive elements and their associated ground conductors, may have uniform pitches. Disposing the first flaps 757 between adjacent groups of conductive elements enables the techniques as described herein to be mounted on a PCB manufactured according to a standard for which pads or through holes for high-speed signal pairs are separated by a single ground pad or through hole. The tubular structures 666 around the groups provided by the shielding shell 733 may be grounded on both sides of the respective groups, which enables the receptacle connector 500 to carry high-speed signals.

Although not shown, it should be appreciated that In some embodiments, the first shell part 702 may have a second flap similar to the aforementioned second flap 358 to join two first flaps 757 corresponding to the same tubular structure 666. As such, the first shell part 702 may provide three sides of the multi-dimensional shielding at the tails. It should also be appreciated that the second shell part 704 may include rear pieces similar to the aforementioned rear pieces 359. Each rear piece forms an annular portion with two first flaps 757 and a second flap corresponding to the same tubular structure 666 to surround the tails 714 of a corresponding group of conductive elements 762. In this manner, shielding may be provided on all four sides at the tails.

The flap 757 may be aligned with corresponding sides 806 in the mating direction MD, or may be offset from the corresponding side 806 in the mating direction MD.

In some embodiments, the first shell part 702 may include a plurality of subparts (the subparts 702a, 702b, and 702c as shown in FIGS. 10A and 10B). Each of the plurality of subparts includes at least one plateau 802, at least two sides 806, and at least a portion of at least one valley 804, with the plurality of subparts connected to each other at the valley 804. For example, the plurality of subparts may be combined into one structure through, for example, matching features 708. In this case, two adjacent first flaps 757 of two adjacent subparts may be configured to be connected to the same conductive pad or conductive through hole of a circuit board. In some embodiments, the first shell part 702 may be a single monolithic member.

The present application also proposes a method for forming the connector subassemblies 600 and receptacle connectors 500. The second shell part 704 of the shielding shell 733 may be formed by stamping a metal sheet into one-piece blank. The one-piece blank may be formed, such as by folding, into the shape illustrated in FIGS. 7G and 7H. The first shell part 702 may be formed by stamping a metal sheet into one-piece blank, which may be folded to have the shape shown in FIGS. 7G and 7H; or the first shell part 702 may be formed by stamping one or more metal sheets into multiple subparts (e.g., subparts 702a, 702b, and 702c shown in FIGS. 10A and 10B), each of which may be folded to have at least one plateau 802, at least two sides 806, and at least one portion of at least one valley 804. The multiple subparts may be then combined into one structure through, for example, matching features 708. As shown in FIGS. 7G and 10A, the valleys 804 of the first shell part 702 may have openings 852 extending therethrough and aligned in a line. The lead assembly 706 may be inserted into the first shell part 702 by aligning and placing the connecting portions 710 of the insulative member 720 to the line of the openings 852. The second shell part 704 may be then attached (e.g., by welding) to the first shell part 702 to form the connector subassembly 600. The connector subassembly 600 may be then disposed into the channel 610 of the housing 502 of the plug connector 500.

In some embodiments, housing components, such as the housings 102 and 502, and insulative members 320 and 720 may be dielectric members molded from a dielectric material such as plastic or nylon. Examples of suitable materials include, but are not limited to, liquid crystal polymer (LCP), polyphenylene sulfide (PPS), high temperature nylon or polyphenylene oxide (PPO) or polypropylene (PP). Other suitable materials may be employed, as aspects of the present disclosure are not limited in this regard.

In some embodiments, conductive elements such as signal conductors 362 and 762 may be made of metal or any other material that is conductive and provides suitable mechanical properties for conductive elements in an electrical connector. Phosphor-bronze, beryllium copper and other copper alloys are non-limiting examples of materials that may be used. The conductive elements may be formed from such materials in any suitable way, including by stamping and/or forming.

Connector construction techniques as described herein may be used to improve performance of an electrical connector, particularly a miniaturized connector in which space is constrained by a standard such as SFF-8639. The structures described herein that lead to repeatable manufacture of connectors in mass production may also impact the performance of the connector. Repeatable manufacture, for example, results in connectors that in practice exhibit little variation in impedance or other electrical properties. Limiting such variations in turn enhances the integrity of signals passing through the connector, which may be seen for example by low crosstalk for the range or ranges of frequencies of interest.

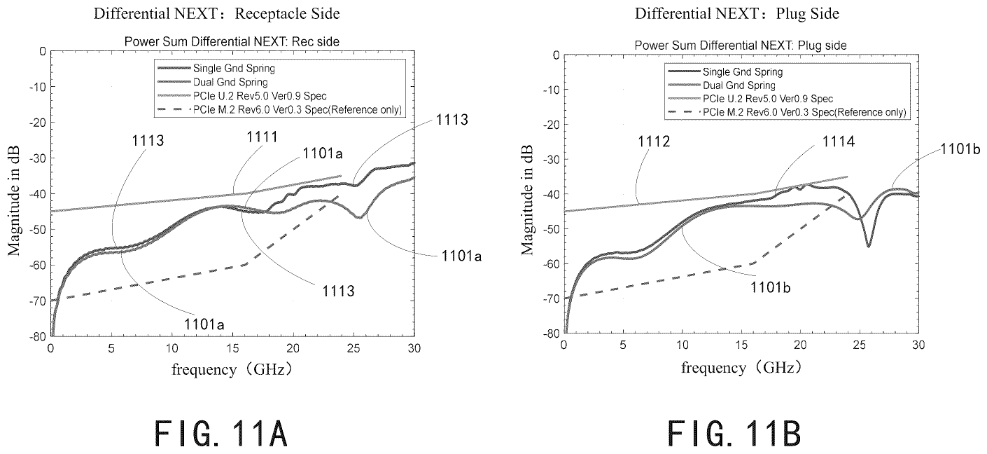

FIGS. 11A and 11B illustrate the near end crosstalk (NEXT) as a function of frequency for the receptacle connector 500 and the plug connector 100, respectively, compared to prior designs and industry standards. As illustrated, in the range of 0-15 GHZ, curve 1101a for the receptacle connector 500 and curve 1101b for the plug connector 100 are below the requirements by the industry standards shown as curves 1111 and 1112, respectively, and are below the curve 1113 of a prior receptacle connector and the curve 1114 of a prior plug connector (e.g., the prior connector only has a single ground structure between adjacent groups of conductive elements). This shows that the connector construction techniques as described herein enable the connectors to satisfy the industry standards and to perform better than the prior connectors.

Although details of specific configurations of conductive elements and shells are described above, it should be appreciated that such details are provided solely for purposes of illustration, as the concepts disclosed herein are capable to be implemented in other manners. In that respect, various connector designs described herein may be used in any suitable combination, as aspects of the present disclosure are not limited to the particular combinations shown in the drawings.

Having thus described several embodiments, it is to be appreciated various alterations, modifications, and improvements may readily occur to those skilled in the art.

For example, techniques as described herein may be embodied in card edge connectors or connectors configured only for high-speed signals.

In some embodiments, although a dual ground resilient arm (spring arm) configuration is described in connection with the example of a receptacle connector, it should be appreciated that alternatively, the shielding shell of the plug connector may be configured to have a dual ground resilient arm configuration. In such a case, the shielding shell or ground terminal of a receptacle connector mating with such a plug connector may have a blade-type mating contact portion.

In some embodiments, high-speed and low-speed signal conductors may be configured to be the same, with signal conductors in the same row having the same shapes. The high-speed and low-speed signal conductors nonetheless may be differentiated based on the ground structures and insulative portions around them. Alternatively, some or all of the high-speed signal conductors may be configured to be different from low-speed signal conductors, even within the same row. The edge-to-edge spacing may be closer for high-speed signal conductors, for example.

Embodiments are illustrated in which the shielding shell includes a first shell part and a second shell part attached to the first shell part. The second shell part may have mounting portions. In other examples, however, the first shell part may include mounting portions

In some embodiments, connectors are illustrated to have mating locations and mounting locations that may be compatible with a PCIeSAS standard. Techniques as described herein may be used to increase the operating speed of connectors designed according to other standards.

As yet another example, a plug connector is illustrated with mating contact portions of a first configuration and a receptacle connector is illustrated with mating contact portions with second complementary structures. A plug connector and receptacle connector may, in other examples, have the configurations of the mating contact portions reversed or mixed.

Also, exemplary connectors are illustrated in which an entire row is formed as a subassembly with a shielding shell and a lead assembly. Other examples may have multiple subassemblies per row.

As another example, exemplary connectors are illustrated in which each subassembly is formed with a first shell part and a second shell part. Other number of shell parts may be used in other examples. For example, a single first shell part may be used on one side of a subassembly, but multiple second shell parts may be attached to that first shell part. Each of the multiple second shell parts may complete one or more of the tubular structures of the subassembly.

Such alterations, modifications, and improvements are intended to be within the spirit and scope of the application. Accordingly, the foregoing description and drawings are by way of example only.

Furthermore, techniques for increasing the operating speed of a connector, even when constrained by dimensions specified in an industry standard, are shown and described with reference to a plug connector having a parallel board configuration, and a receptacle connector, it should be appreciated that aspects of the present disclosure are not limited in this regard, as any of the inventive concepts, whether alone or in combination with one or more other inventive concepts, may be used in other types of electrical connectors, such as card edge connectors, backplane connectors, right angle connectors, stacking connectors, mezzanine connectors, I/O connectors, chip sockets, etc.

In some embodiments, tails are illustrated as surface mount elements that are designed to fit within pads of circuit boards. However, other configurations may also be used, such as press fit “eye of the needle” compliant sections, spring contacts, solderable pins, etc.

All definitions, as defined and used, should be understood to control over dictionary definitions, definitions in documents incorporated by reference, and/or ordinary meanings of the defined terms.

Numerical values and ranges may be described in the specification and claims as approximate or exact values or ranges. For example, in some cases the terms “about,” “approximately,” and “substantially” may be used in reference to a value. Such references are intended to encompass the referenced value as well as plus and minus reasonable variations of the value.

In the claims, as well as in the specification above, all transitional phrases such as “comprising,” “including,” “carrying,” “having,” “containing,” “involving,” “holding,” “composed of,” and the like are to be understood to be open-ended, e.g., to mean including but not limited to. Only the transitional phrases “consisting of” and “consisting essentially of” shall be closed or semi-closed transitional phrases, respectively.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A shielding shell for an electrical connector configured to engage a mating component in a mating direction, the electrical connector comprising a plurality of groups of conductive elements, each conductive element comprising a mating end, a tail, and an intermediate portion joining the mating end and the tail, the shielding shell comprising:
a plurality of first portions;
a plurality of openings aligned in a row direction perpendicular to the mating direction, each of the plurality of openings disposed between adjacent first portions of the plurality of first portions such that the mating ends of a group of the plurality of groups of conductive elements are exposed through an opening of the plurality of openings; and
a second portion joining the plurality of first portions, the second portion comprising a body and a plurality of contact arms curving away from the body and configured to contact a complementary conductive member of the mating component.

2. The shielding shell of claim 1, wherein:
the plurality of contact arms are aligned in the row direction; and
each of the plurality of contact arms is aligned with a respective first portion of the plurality of first portions in the mating direction.

3. The shielding shell of claim 2, wherein:
the plurality of contact arms of the second portion are a plurality of second contact arms; and
each of the plurality of first portions comprises a first contact arm aligned with a respective second contact arm of the plurality of second contact arms in the mating direction to form pairs of contact arms.

4. The shielding shell of claim 3, wherein, for each pair of contact arms:
the first contact arm and the second contact arm are spaced apart such that the first contact arm and the second contact arm contact the complementary conductive member of the mating component at different locations.

5. The shielding shell of claim 3, wherein:
each of the plurality of first contact arms comprises a first proximal end joined with a body of the respective first portion and a first distal end;
each of the plurality of second contact arms comprises a second proximal end joined with the body of the second portion and a second distal end; and
for each pair of contact arms, the first distal end of the first contact arm and the second distal end of the second contact arm are disposed between the first proximal end of the first contact arm and the second proximal end of the second contact arm.

6. A connector subassembly comprising:
an insulative member;
a plurality of conductive elements held by the insulative member in a row direction and disposed in a plurality of groups of conductive elements, each conductive element comprising a mating end, a tail, and an intermediate portion joining the mating end and the tail, wherein:
the plurality of groups of conductive elements comprise a plurality of pairs of conductive elements; and
for each pair of conductive elements, the mating ends are spaced apart from each other by a first center-to-center pitch in the row direction, the intermediate portions are spaced apart from each other by a second center-to-center pitch in the row direction, and the first center-to-center pitch is greater than the second center-to-center pitch.

7. The connector subassembly of claim 6, wherein:
for each conductive element of the plurality of pairs of conductive elements, the mating end has a convexly curved shape and is narrower than the intermediate portion in the row direction.

8. The connector subassembly of claim 6, wherein:
for each conductive element of the plurality of pairs of conductive elements, both the mating end and the intermediate portion are blade-shaped, and the mating end has a same width as the intermediate portion in the row direction; and
each conductive element of the plurality of pairs of conductive elements comprises a transition portion between the mating end and the intermediate portion, the transition portion is curved in a vertical direction perpendicular to both the row direction and the mating direction.

9. The connector subassembly of claim 6, further comprising:
a shielding shell comprising a plurality of first openings, wherein:
the intermediate portions of the plurality of conductive elements are disposed within the shielding shell such that the mating ends of the conductive elements in each group of the plurality of groups are exposed through a first opening of the plurality of first openings.

10. The connector subassembly of claim 9, wherein:
the shielding shell comprises a plurality of first portions each disposed between adjacent groups of the plurality of groups; and
each first portion of the plurality of first portions of the shielding shell is spaced apart from the mating end of an adjacent conductive element by the first center-to-center pitch in the row direction.

11. The connector subassembly of claim 10, wherein:
the shielding shell comprises a plurality of first contact arms each curving away from a respective first portion of the plurality of first portions; and
each first contact arm of the plurality of first contact arms is spaced apart from the mating end of the adjacent conductive element by the first center-to-center pitch in the row direction.

12. The connector subassembly of claim 11, wherein:
the mating ends of the plurality of conductive elements comprise mating contact surfaces disposed in a first plane; and
the plurality of first contact arms comprise mating contact surfaces disposed in a second plane offset from the first plane in a vertical direction perpendicular to both the row direction and the mating direction.

13. The connector subassembly of claim 12, wherein:
the shielding shell comprises a second portion joining the plurality of first portions, and a plurality of second contact arms curving away from the second portion; and
the plurality of first contact arms comprise mating contact surfaces disposed in the second plane.

14. The connector subassembly of claim 13, wherein:
the shielding shell comprises a plurality of second openings; and
the tails of the conductive elements in each group of the plurality of groups are exposed through a second opening of the plurality of second openings.

15. The connector subassembly of claim 14, wherein the shielding shell comprises:
a first shell part comprising a plurality of plateaus, a plurality of valleys, and sides joining adjacent plateaus and valleys; and
a second shell part comprising the plurality of first openings, wherein:
each valley of the plurality of valleys is disposed between adjacent groups of the plurality of groups; and
the second shell part is attached to the first shell part at the plurality of valleys so as to form a plurality of tubular structures, each tubular structure comprising a plateau of the plurality of plateaus of the first shell, sides of the first shell joining the plateau to respective valleys, and a portion of the second shell part opposing the plateau of the first shell in the vertical direction.

16. The connector subassembly of claim 15, wherein:
the first shell part further comprises a plurality of first flaps disposed between adjacent second openings of the plurality of second openings of the shielding shell so as to separate adjacent groups of the plurality of groups in the row direction; and
adjacent first flaps that separate same adjacent groups of conductive elements in the row direction form a plurality of first flap pairs each configured to be connected to a same conductive pad of a circuit board.

17. The connector subassembly of claim 16, wherein:
the tail of each conductive element comprises a first mounting contact surface;
each first flap pair comprises a second mounting contact surface; and
for each group of the plurality of groups of conductive elements, the tails of two adjacent conductive elements are spaced apart from each other by a third center-to-center pitch in the row direction, each first flap pairs is spaced apart from the tail of an adjacent conductive element by a fourth center-to-center pitch in the row direction, and the fourth center-to-center pitch is equal to the third center-to-center pitch.

18. The connector subassembly of claim 17, wherein:
the first shell part further comprises a plurality of second flaps; and
each second flap extends from a plateau of the plurality of plateaus and joins two first flaps that correspond to a same tubular structure.

19. An interconnection system comprising:
a pair of mating electrical connectors comprising a first connector and a second connector, each of the first connector and the second connector comprising:
an insulative member;
a plurality of conductive elements held by the insulative member in a row direction and disposed in a plurality of groups of conductive elements, each conductive element comprising a mating end, a tail, and an intermediate portion joining the mating end and the tail; and
a shielding shell comprising a plurality of openings, the intermediate portions of the plurality of conductive elements are disposed within the shielding shell such that the mating ends of the conductive elements in each group of the plurality of groups are exposed through an opening of the plurality of openings, wherein:
the shielding shell of a first connector of the pair of mating electrical connectors comprises a plurality of contact arms aligned with the intermediate portions of the plurality of conductive elements of the first connector, and positioned such that the plurality of contact arms contact the shielding shell of a second connector of the pair of mating electrical connectors at locations closer to a distal end of the shielding shell of the second connector than mating locations of the mating ends of the conductive elements of the pair of mating electrical connectors.

20. The interconnection system of claim 19, wherein:
the plurality of contact arms are a plurality of second contact arms;
the shielding shell of the first connector of the pair of mating electrical connectors comprises a plurality of first contact arms aligned with the mating ends of the plurality of conductive elements of the first connector; and
the plurality of groups of conductive elements of each of the pair of mating electrical connector comprises a plurality of pairs of conductive elements, and the mating ends of each pair of conductive elements are spaced farther apart from each other in the row direction than the respective intermediate portions.
